(19) United States
(12) Patent Application Publication
(10) Pub. No.: US 2015/0319671 A1
(43) Pub. Date: Nov. 5, 2015

(54) CONTROL APPARATUS, COMMUNICATION APPARATUS AND CONTROL METHOD

(71) Applicant: FUJITSU LIMITED, Kawasaki-shi (JP)

(72) Inventor: Keiichi Nakatsugawa, Shinagawa (JP)

(21) Appl. No.: 14/687,242

(22) Filed: Apr. 15, 2015

(30) Foreign Application Priority Data
May 1, 2014 (JP) 2014-094568

(51) Int. Cl. H04W 40/22; H04B 7/14; H04W 72/04

(52) U.S. Cl. CPC H04W 40/22; H04W 72/042; H04B 7/14

(57) ABSTRACT

A control apparatus including: a network interface configured to communicate with a plurality of networks including a first network and coupling each other via a plurality of relaying apparatus, the first network including a communication apparatus that receives a packet addressed to a first address provided for a specific terminal from the first network and transmits the received packet to a second address provided for the specific terminal from a second network in the plurality of networks when the specific terminal couples to the second network, and a processor configured to: identify at least one relaying apparatus lying between the communication apparatus and the specific terminal that couples to the second network from among the plurality of relaying apparatus, and transmit at least one control packet controlling the at least one relaying apparatus so that a packet addressed to the first address is relayed to the second address.

### CROSS-REFERENCE TO RELATED APPLICATION

This application is based upon and claims the benefit of priority from the prior Japanese Patent Application No. 2014-094568 filed on May 1, 2014, the entire contents of which are incorporated herein by reference.

### FIELD

The present embodiments discussed herein are related to a forwarding method of a packet in a network that includes a plurality of apparatus.

### BACKGROUND

If a mobile internet protocol (IP) technology is used, then while an IP terminal coupled to an IP network keeps a communication session of an application in a coupled state, the coupling position of the IP terminal to the IP network can be changed. FIG. 1 is a diagrammatic view depicting an example of communication that uses a mobile IP technology. The network depicted in FIG. 1 includes subnetworks 5a to 5c. The subnetwork 5a is a home subnetwork of a mobile terminal 10 and includes a home agent (HA) 3. It is assumed that the subnetworks 5a to 5c are coupled in such a manner as depicted in FIG. 1 by relaying apparatus 2a to 2d. The mobile terminal 10 has a home address (HoA) allocated thereto. The home address is an unchanged IP address allocated to the mobile terminal 10 and is an address that belongs to the home subnetwork. When the mobile terminal 10 moves to a subnetwork such as the subnetwork 5c other than the home subnetwork (arrow mark A), the mobile terminal 10 acquires or generates a care-of address (CoA) that belongs to the subnetwork of the destination of the movement. Thereafter, the mobile terminal 10 registers the care-of address into the home agent 3 (arrow mark B).

If a packet P1 destined for the mobile terminal 10 is transmitted from a communication apparatus 15 when the mobile terminal 10 is not positioned in the home subnetwork, then the home agent 3 receives the packet P1 by proxy. The destination address of the packet P1 is the home address of the mobile terminal 10, and the transmission source address is the address (CN) of the communication apparatus 15. It is to be noted that, in the header of packets in FIG. 1, the transmission source address is represented as SA (Source Address) and the destination address is represented as DA (Destination Address).

The home agent 3 assigns, to the packet P1, a header that designates the CoA of the mobile terminal 10 as the destination address and the address (HA) of the home agent 3 as the transmission source address to generate a packet P2. The home agent 3 forwards the packet P2 to the mobile terminal 10 in the subnetwork 5c. The header used for encapsulation is hereinafter referred to as outer header, and the header in the encapsulated packet is hereinafter referred to as inner header.

On the other hand, the mobile terminal 10 generates a packet P3 as a response to the packet P2 and transmits the packet P3 to the home agent 3. Also the packet P3 is in an encapsulated state, and the destination address of the outer header is designated to the home agent 3, and the transmission source address is designated to the CoA of the mobile terminal 10. In the inner header of the packet P3, the destination address is an address of the communication apparatus 15 and the transmission source address is the HoA of the mobile terminal 10. When the home agent 3 receives the packet P3, it performs decapsulation of the packet P3 to remove the outer header from the packet P3 and transmits a resulting packet P4 to the communication apparatus 15.

In recent years, as a technology for performing flexible packet forwarding control, OpenFlow is occasionally used. The relaying apparatus 2a to 2d depicted in FIG. 1 may each be an apparatus used in OpenFlow (OpenFlow Switch, OFS). In this case, an OpenFlow controller (OFC) 4 notifies the relaying apparatus 2a to 2d of a condition for the identification of a flow of a control target and a process to be performed for a packet of the flow that satisfies the condition. The relaying apparatus 2a to 2d perform processes in accordance with the notification from the OFC 4.

As a related art, a mobile router has been proposed which includes a communication attribute table indicating route selection information in an associated relationship with flow conditions and a forwarding processing unit. The mobile router determines, in response to the route selection information, an optimum route to an apparatus of the communication destination as a forwarding route for a received packet and which one of mobile tunnels set with respect to a home agent is to be used (for example, Patent Document 1). Also a home agent has been proposed which distributes, when a mobile terminal moves, an IP tunnel setting that designates transmission destination information to be used for transmission to the mobile terminal to a plurality of IP tunnel routers (for example, Patent Document 2). When each IP tunnel router receives a packet whose transmission destination is the mobile terminal, the IP tunnel router forwards the packet without by way of the home agent on the basis of the IP tunnel setting information. Also a system has been proposed wherein a home agent selects a virtual home agent that provides a service better than the service provided by the home agent to a mobile terminal and the virtual home agent is notified of the CoA of the mobile terminal (for example, Patent Document 3).

### PRIOR ART DOCUMENT

### Patent Document

[Patent Document 1] Japanese Laid-open Patent Publication No. 2006-50035
[Patent Document 2] International Publication No. 03/071749
[Patent Document 3] Japanese National Publication of International Patent Application No. 2013-532920

### Non-Patent Document

[Non-Patent Document 1] “RFC3220 IP Mobility Support for IPv4,” [online], January 2002, IETF, [searched on Apr. 2, 2014], <http://www.ietf.org/rfc/rfc3220.txt>
[Non-Patent Document 2] “RFC3775 Mobility Support in IPv6,” [online], June 2004, IETF, [searched on Apr. 2, 2014], <http://www.ietf.org/rfc/rfc3775.txt>
[Non-Patent Document 3] “OpenFlow Switch Specification Version 1.4.0,” [online], Oct. 14, 2013, OPEN NETWORKING FOUNDATION, [searched on Apr. 2, 2014], <https://www.opennetworking.org/images/stories/downloads/sdn-resources/onf-specifications/openflow/openflow-spec-v1.4.0.pdf>

### SUMMARY

According to an aspect of the invention, a control apparatus includes a network interface configured to communicate with a plurality of networks including a first network, the plurality of networks coupling each other via a plurality of relaying apparatus, the first network including a communication apparatus that receives a packet addressed to a first address and transmits the received packet to a second address, the first address being provided for a specific terminal from the first network, the second address being provided for the specific terminal from a second network in the plurality of networks when the specific terminal couples to the second network, and a processor configured to: identify at least one relaying apparatus from among the plurality of relaying apparatus, the at least one relaying apparatus lying between the communication apparatus and the specific terminal that couples to the second network, and transmit at least one control packet to the at least one relaying apparatus, the at least one control packet controlling the at least one relaying apparatus so that a packet addressed to the first address is relayed to the second address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagrammatic view depicting an example of communication that uses a mobile IP technology;

FIG. 2 is a diagrammatic view depicting an example of a communication method according to an embodiment;

FIG. 3 is a diagrammatic view depicting an example of a network;

FIG. 4 is a block diagram depicting an example of a configuration of a conversion apparatus;

FIG. 5 is a block diagram depicting an example of a configuration of a control apparatus;

FIG. 6 is a view depicting an example of a topology information table;

FIG. 7 is a view depicting an example of a coupling information table;

FIG. 8 is a view depicting an example of a flow table;

FIG. 9 is a block diagram depicting an example of a configuration of a relaying apparatus;

FIG. 10 is a view depicting an example of a flow table held by a relaying apparatus;

FIG. 11 is a block diagram depicting an example of a hardware configuration;

FIG. 12 is a sequence diagram depicting an example of processing performed when a mobile terminal moves;

FIG. 13 is a view depicting an example of authentication information;

FIG. 14 is a view depicting an example of position registration information;

FIG. 15 is a view depicting an example of a change of a flow table;

FIG. 16 is a view depicting an example of a relaying apparatus information table;

FIG. 17 is a view depicting an example of a flow table after updated;

FIG. 18 is a sequence diagram depicting an example of processing performed upon transmission and reception of a packet to and from a mobile terminal;

FIG. 19 is a flow chart illustrating an example of processing of a conversion apparatus;

FIG. 20 is a flow chart illustrating an example of processing of a control apparatus;

FIG. 21 is a flow chart illustrating an example of processing of a relaying apparatus;

FIG. 22 is a block diagram depicting an example of a configuration of a conversion apparatus according to a second embodiment;

FIG. 23 is a sequence diagram depicting an example of processing performed when a flow table is updated using a transmission process of a packet destined for a mobile terminal as a trigger;

FIG. 24 is a sequence diagram depicting an example of processing performed when a flow table is updated using a transmission process of a packet from a mobile terminal as a trigger;

FIG. 25 is a flow chart illustrating an example of processing of a conversion apparatus;

FIG. 26 is a block diagram depicting an example of a configuration of a control apparatus according to a third embodiment;

FIG. 27 is a view depicting an example of a flow table;

FIG. 28 is a view depicting an example of a flow table held by a relaying apparatus;

FIG. 29 is a block diagram depicting an example of a configuration of a conversion apparatus according to the third embodiment;

FIG. 30 is a sequence diagram depicting an example of processing performed upon change of a flow table in the third embodiment;

FIG. 31 is a view depicting an example of a change of a flow table;

FIG. 32 is a view depicting an example of a flow table after updated; and

FIG. 33 is a flow chart illustrating an example of processing of a control apparatus.

### DESCRIPTION OF EMBODIMENTS

When a mobile terminal performs communication on a subnetwork other than a home subnetwork, since a data packet to be transmitted to or received by the mobile terminal is forwarded through a home agent, the data packet has an encapsulated form. Accordingly, in comparison with an alternative case in which a packet is transmitted without being encapsulated, the data amount to be transmitted and received increases by an amount of data of a header used for packet forwarding along a path between the home subnetwork and the subnetwork of the destination of the movement. Whichever one of the technologies described as related art hereinabove is used, the problem of the transmission amount by encapsulation remains unsolved. For example, with the method of determining whether or not the forwarding route of a packet is to include the home agent in accordance with route selection information, a flow that is not set as route selection information is not forwarded without passing the home agent.

The present embodiments disclosed herein are effective to forward a packet without encapsulation to a mobile terminal positioned in a subnetwork of a destination of movement of the mobile terminal.

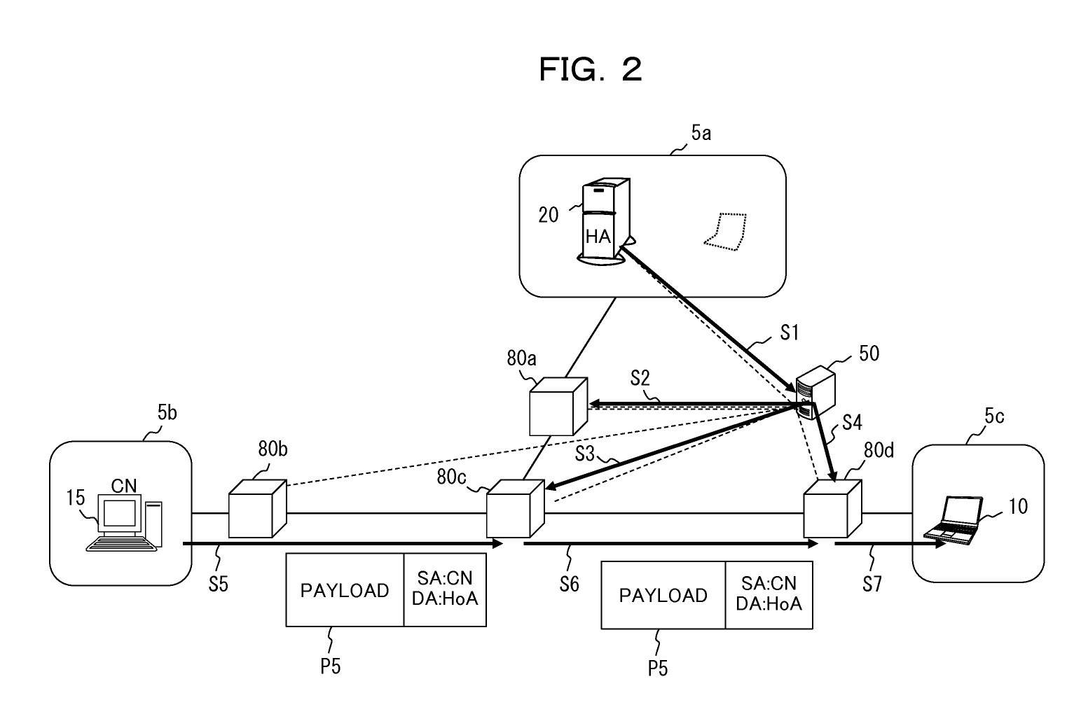

FIG. 2 is a diagrammatic view depicting an example of a communication method according to an embodiment. Also FIG. 2 depicts an example wherein a network includes subnetworks 5a to 5c and the subnetwork 5a is a home network of a mobile terminal 10. Furthermore, also in the example of FIG. 2, it is assumed that the mobile terminal 10 moves to the subnetwork 5c. Also it is assumed that a communication apparatus 15 that communicates with the mobile terminal 10 is positioned in the subnetwork 5b. Further, it is assumed that a control apparatus 50 uses a technology such as OpenFlow to control the behavior of relaying apparatus 80 (80a to 80d) in the network.

A conversion apparatus 20 (may referred to as a communication apparatus) is provided in the subnetwork 5a. It is assumed that the conversion apparatus 20 operates as a home agent of the mobile terminal 10. When the mobile terminal 10 moves to the subnetwork 5c, the mobile terminal 10 issues a request for position registration to the conversion apparatus 20. After the position registration of the mobile terminal 10 is completed, the conversion apparatus 20 notifies the control apparatus 50 of a care-of address (CoA) and a home address (HoA) allocated to the mobile terminal 10 (step S1).

It is assumed that the control apparatus 50 stores in advance therein information representative of a topology in the network and coupling destinations of ports of each relaying apparatus 80. Further, the control apparatus 50 stores therein also information of a flow table used by each relaying apparatus 80. In the following description, it is assumed that the flow table is information which associates conditions for determination of an output port for a packet of a forwarding target and output ports with each other.

If the control apparatus 50 is notified of the care-of address of the mobile terminal 10, then the control apparatus 50 uses the care-of address to specify the subnetwork in which the mobile terminal 10 is positioned. Then, the control apparatus 50 selects those relaying apparatus 80 which are included in a route from the conversion apparatus 20 to the mobile terminal 10. In the example of FIG. 2, the control apparatus 50 determines that the relaying apparatus 80a, 80c, and 80d are included in the route from the conversion apparatus 20 to the mobile terminal 10.

The control apparatus 50 requests the selected relaying apparatus 80 to set an output port for a packet destined for the home address of the mobile terminal 10 to a port that is used when a packet is forwarded to an apparatus in the subnetwork 5c (steps S2 to S4). For example, it is assumed that the relaying apparatus 80a outputs a packet destined for an apparatus in the subnetwork 5c to the port 3 thereof. In this case, the control apparatus 50 requests the relaying apparatus 80a to write it into the flow table of the relaying apparatus 80a that a packet destined for the home address of the mobile terminal 10 is to be outputted from the port 3 of the relaying apparatus 80a. A similar process is performed also for the relaying apparatus 80c and 80d.

After change of the flow tables in the relaying apparatus 80a, 80c, and 80d comes to an end, it is assumed that a packet P5 destined for the mobile terminal 10 is transmitted from the communication apparatus 15. The destination of the packet P5 is the home address of the mobile terminal 10. The relaying apparatus 80b forwards the packet P5 to the relaying apparatus 80c in accordance with the flow table thereof (step S5).

The relaying apparatus 80c receives the packet P5 and searches the flow table to specify an output port for the packet P5. In step S3, it is recorded in the flow table that a packet destined for the home address of the mobile terminal 10 is to be outputted from a port same as the port from which a packet destined for an apparatus in the subnetwork 5c is to be outputted. Therefore, the relaying apparatus 80c forwards the packet P5 to the relaying apparatus 80d (step S6).

Upon reception of the packet P5, the relaying apparatus 80d operates similarly to the relaying apparatus 80c, and therefore, the relaying apparatus 80d forwards the packet P5 to the subnetwork 5c (step S7). Therefore, the mobile terminal 10 can receive the packet P5.

In this manner, with the method according to the present embodiment, after movement of the mobile terminal 10, the control apparatus 50 acquires the care-of address and the home address of the mobile terminal 10 in an associated relationship with each other from the conversion apparatus 20 and changes the setting of the relaying apparatus 80 in the route from the conversion apparatus 20 to the mobile terminal 10. Therefore, even if a packet transmitted from the communication apparatus 15 to the mobile terminal 10 is not in an encapsulated state, the packet is transmitted to the mobile terminal 10.

<Example of the Configuration of the Network and the Apparatus>

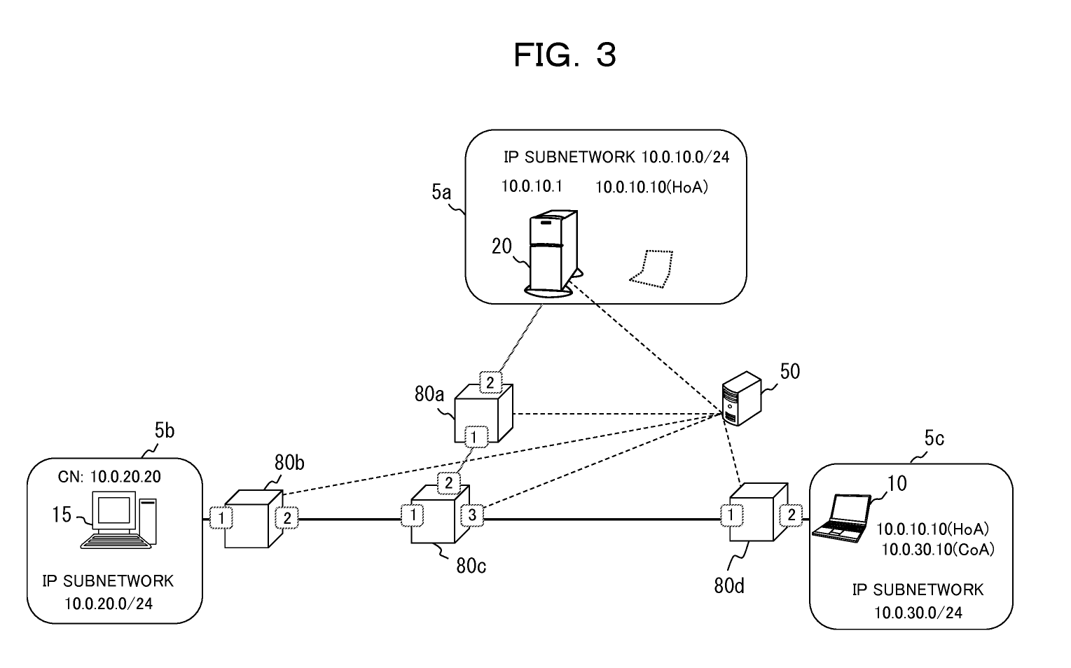

FIG. 3 is a diagrammatic view depicting an example of a network. The following description is given taking communication in the network depicted in FIG. 3 as an example. The network depicted in FIG. 3 includes subnetworks 5a to 5c, and communication between the subnetworks is relayed by relaying apparatus 80a to 80d. It is assumed that the subnetworks have subnetwork addresses allocated thereto such that 10.0.10.0/24 is allocated to the subnetwork 5a; 10.0.20.0/24 is allocated to the subnetwork 5b; and 10.0.30.0/24 is allocated to the subnetwork 5c. Further, it is assumed that the address allocated to the conversion apparatus 20 is 10.0.10.1 and the home address (HoA) of the mobile terminal 10 is 10.0.10.10. Meanwhile, since the mobile terminal 10 moves to the subnetwork 5c, it is assumed that the care-of address (CoA) allocated to the mobile terminal 10 is 10.0.30.10.

The control apparatus 50 can change the substance of a relaying process to be performed by the relaying apparatus 80a to 80d by transmitting a control packet to each of the relaying apparatus 80a to 80d. Further, the control apparatus 50 transmits and receives a control packet to and from the conversion apparatus 20. In the example of FIG. 3, a line used for transmission and reception of a control packet is indicated by a broken line, and a line used for transmission and reception of a data packet is indicated by a solid line. A port number of each relaying apparatus 80 is indicated by a square including a numeral. For example, the relaying apparatus 80a is coupled to the subnetwork 5a through the port 2 thereof and coupled to the relaying apparatus 80c through the port 1 thereof. The relaying apparatus 80b is coupled to the subnetwork 5b through the port 1 thereof and coupled to the relaying apparatus 80c through the port 2 thereof. Further, the relaying apparatus 80d is coupled to the subnetwork 5c through the port 2 thereof and coupled to the relaying apparatus 80c through the port 1 thereof. The port 1 of the relaying apparatus 80c is coupled to the relaying apparatus 80b; the port 2 is coupled to the relaying apparatus 80a; and the port 3 is coupled to the relaying apparatus 80d.

It is to be noted that FIG. 3 depicts an example of the network, and the number and the coupling scheme of the subnetworks 5, the relaying apparatus 80 and so forth included in the network can be changed arbitrarily in response to the implementation of the network.

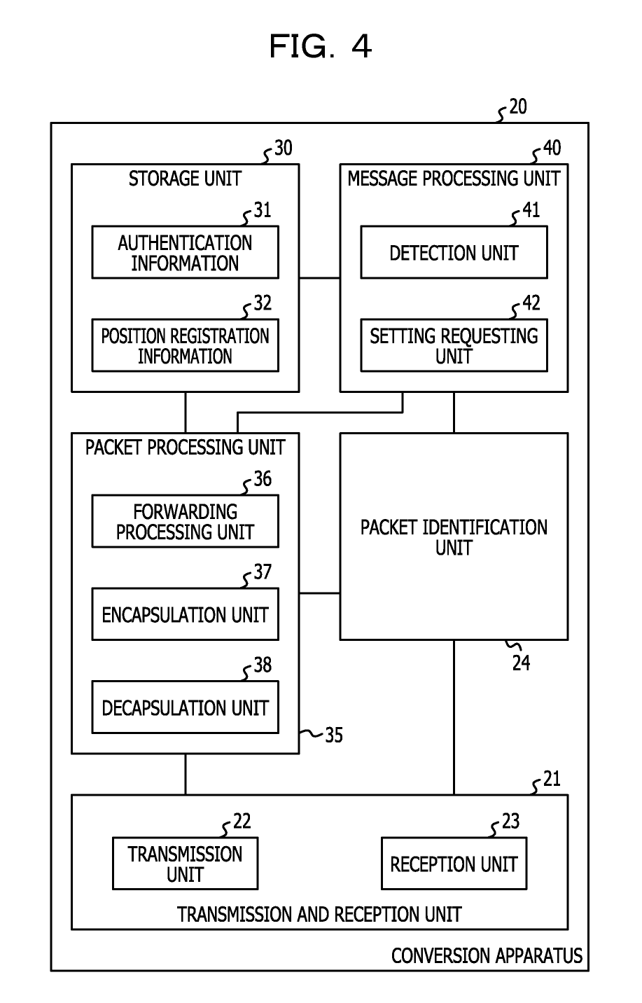

FIG. 4 is a block diagram depicting an example of a configuration of a conversion apparatus. The conversion apparatus depicted in FIG. 4 may be the conversion apparatus 20 depicted in FIG. 2. The conversion apparatus 20 includes a transmission and reception unit 21, a packet identification unit 24, a storage unit 30, a packet processing unit 35, and a message processing unit 40. The transmission and reception unit 21 includes a transmission unit 22 and a reception unit 23. The packet processing unit 35 includes a forwarding processing unit 36, an encapsulation unit 37 and a decapsulation unit 38. The message processing unit 40 includes a detection unit 41 and a setting requesting unit 42. The storage unit 30 has authentication information 31 and position registration information 32 stored therein. The authentication information 31 is used for authentication of a legitimate user of the mobile terminal 10. The position registration information 32 associates the home address and the care-of address of the mobile terminal 10 positioned in a subnetwork other than the home subnetwork with each other.

The transmission unit 22 transmits a packet to the control apparatus 50 or a different apparatus. The reception unit 23 receives a packet from the control apparatus 50 or a different apparatus and outputs the received packet to the packet identification unit 24. The packet identification unit 24 outputs a data packet to the forwarding processing unit 36 and outputs a position registration request message transmitted thereto from the mobile terminal 10 to the detection unit 41. The detection unit 41 updates the position registration information 32 on the basis of the position registration request message and notifies the setting requesting unit 42 that the mobile terminal 10 has moved. The setting requesting unit 42 generates a flow table setting request on the basis of the notification from the detection unit 41 and transmits the flow table setting request to the control apparatus 50 through the transmission unit 22.

The forwarding processing unit 36 outputs a data packet destined for the mobile terminal 10 to the encapsulation unit 37 and outputs a data packet transmitted thereto from the mobile terminal 10 to the decapsulation unit 38. The encapsulation unit 37 encapsulates a packet inputted thereto. At this time, the encapsulation unit 37 sets an address associated with the home address of the mobile terminal 10 in the position registration information 32 to the destination of the outer header and sets the address of the conversion apparatus 20 to the transmission source of the outer header. The decapsulation unit 38 decapsulates a packet inputted thereto. The decapsulation unit 38 outputs, where the mobile terminal 10 of the transmission source of the data packet is set to the position registration information 32, the packet after decapsulation to the transmission unit 22.

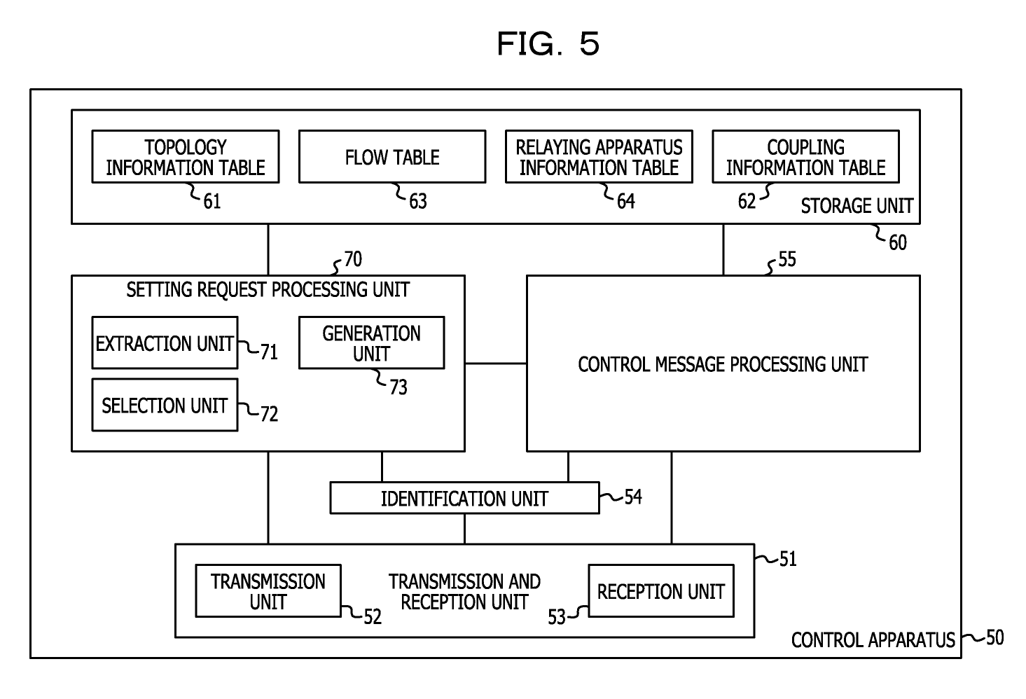

FIG. 5 is a block diagram depicting an example of a configuration of a control apparatus. The control apparatus depicted in FIG. 5 may be the control apparatus 50 depicted in FIG. 2. The control apparatus 50 includes a transmission and reception unit 51, an identification unit 54, a control message processing unit 55, a storage unit 60, and a setting request processing unit 70. The transmission and reception unit 51 includes a transmission unit 52 and a reception unit 53. The reception unit 53 outputs a received packet to the identification unit 54. The identification unit 54 outputs, when the received packet is a flow table setting request transmitted from the conversion apparatus 20, the flow table setting request to an extraction unit 71 of the setting request processing unit 70. On the other hand, if the transmission source of the received packet is a relaying apparatus 80, the identification unit 54 determines that a control message is received and outputs the inputted packet to the control message processing unit 55. The control message processing unit 55 processes the control message received from the relaying apparatus 80 and suitably performs a process for controlling operation of the relaying apparatus 80 of the transmission source of the control message such as notification of an output port for a packet held by the relaying apparatus 80.

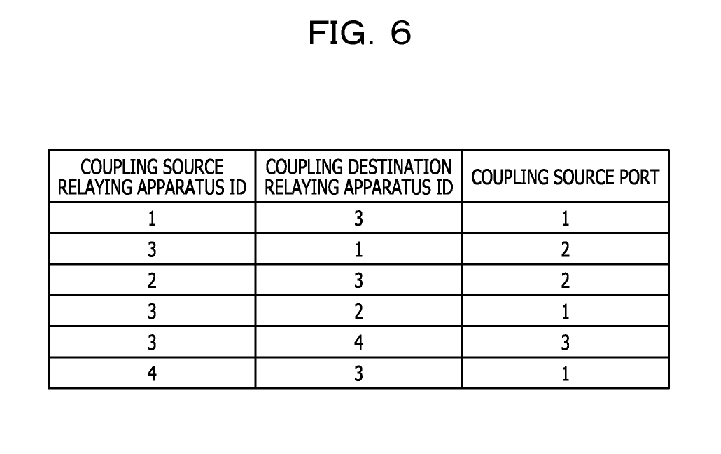

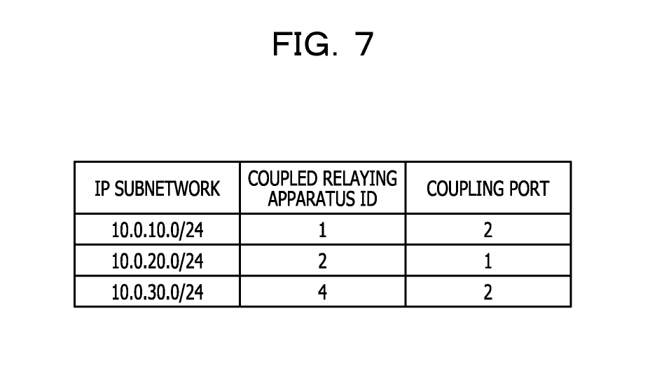

The setting request processing unit 70 includes the extraction unit 71, a selection unit 72, and a generation unit 73. The extraction unit 71 extracts the home address and the care-of address of the mobile terminal 10 from the flow table setting request. The selection unit 72 uses the extracted care-of address and a topology information table 61 (FIG. 6) and a coupling information table 62 (FIG. 7) of the storage unit 60 to specify the relaying apparatus 80 included in the route from the home subnetwork to the subnetwork of the destination of movement in which the mobile terminal 10 is positioned from among the relaying apparatus 80 included in the network. In other words, the selection unit 72 selects those relaying apparatus 80 in the route from the home subnetwork to the subnetwork of the destination of movement in which the mobile terminal 10 is positioned as relaying apparatus 80 to each of which a request for rewriting of the flow table is to be issued. The generation unit 73 changes a flow table 63 in the storage unit 60 in response to the movement of the mobile terminal 10 and generates a control packet for notifying the selected relaying apparatus 80 of the information in the flow table 63 after the change. The control packet is transmitted to the relaying apparatus 80 through the transmission unit 52. It is to be noted that the control apparatus 50 presumably holds, for each of the relaying apparatus 80 of the control target, information of an address to be used for transmission of a control packet and so forth as a relaying apparatus information table 64 in the storage unit 60. The storage unit 60 has stored therein the topology information table 61, the coupling information table 62 and the flow table 63 in addition to the relaying apparatus information table 64.

FIG. 6 is a view depicting an example of a topology information table. The topology information table depicted in FIG. 6 may be the topology information table 61 depicted in FIG. 5. The topology information table 61 has recorded therein, for each of identifiers allocated to the individual relaying apparatus 80 (relaying apparatus IDs), information that specifies serial numbers of ports used by the relaying apparatus 80 of the coupling source. In the following description, it is assumed that the relaying apparatus 80a has a relaying apparatus ID=1; the relaying apparatus 80b has a relaying apparatus ID=2; the relaying apparatus 80c has a relaying apparatus ID=3; and the relaying apparatus 80d has a relaying apparatus ID=4. In the topology information table 61 depicted in FIG. 6, combinations of a coupling source and a coupling destination of a link among the relaying apparatus 80 and a port number used in the relaying apparatus 80 of the coupling source are recorded where the network is formed in such a manner as depicted in FIG. 3. For example, the first entry of the topology information table 61 indicates the coupling source relaying apparatus ID=1 and the coupling destination relaying apparatus ID=3, and therefore indicates that the relaying apparatus 80a is the coupling source and the relaying apparatus 80c is the coupling destination. Further, since the first entry indicates that the coupling source port is 1, it is indicated that the port 1 of the relaying apparatus 80a is coupled to the relaying apparatus 80c. Also from the other entries, a coupling source and a coupling destination of a link can be specified similarly.

FIG. 7 is a view depicting an example of a coupling information table. The coupling information table depicted in FIG. 7 may be the coupling information table 62 depicted in FIG. 5. The coupling information table 62 of FIG. 7 associates an ID of a relaying apparatus 80 coupled to a subnetwork 5 (coupled relaying apparatus ID) and a port of the relaying apparatus 80 with a subnetwork address of the subnetwork 5. For example, the subnetwork address of the subnetwork 5a is 10.0.10.0/24, and the port 2 of the relaying apparatus 80a is coupled to the subnetwork 5a. Therefore, the coupling information relating to the subnetwork 5a is such as indicated by the first entry in FIG. 7. Similarly, the subnetwork address of the subnetwork 5b is 10.0.20.0/24, and the port 1 of the relaying apparatus 80b is coupled to the subnetwork 5b. Therefore, the coupling information relating to the subnetwork 5b is such as indicated by the second entry in FIG. 7. Furthermore, the subnetwork address of the subnetwork 5c is 10.0.30.0/24 and the port 2 of the relaying apparatus 80d is coupled to the subnetwork 5c. Therefore, the coupling information relating to the subnetwork 5c is such as indicated by the third entry in FIG. 7.

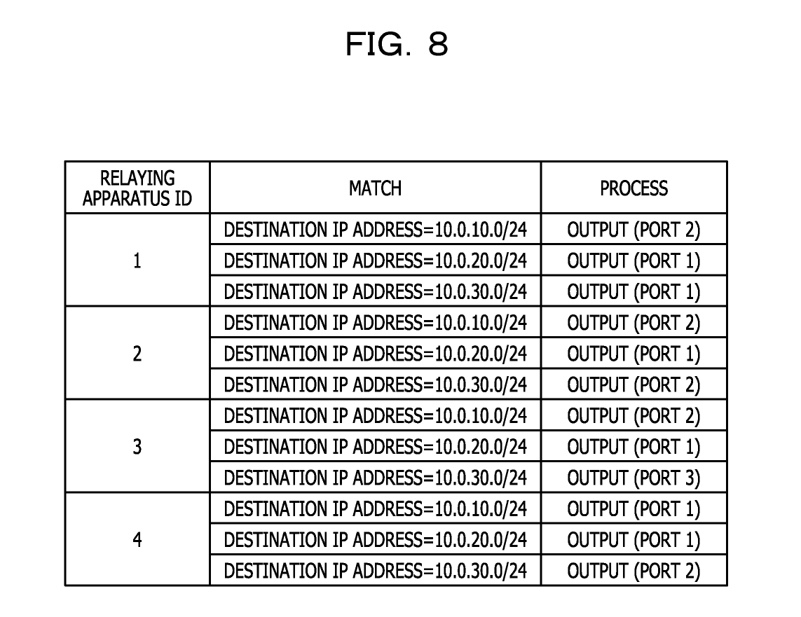

FIG. 8 is a view depicting an example of a flow table. The flow table depicted in FIG. 8 may be the flow table 63 depicted in FIG. 5. The flow table 63 associates information included in the flow table used in a forwarding process by each relaying apparatus 80 with the relaying apparatus ID allocated to the relaying apparatus 80 that retains the information. It is to be noted that, in the example of FIG. 8, conditions used for communication with the control apparatus 50 by each relaying apparatus 80 are omitted. A process set in a column of process in an entry of the greatest bit number that indicates coincidence between a destination address of a packet and a match condition is performed for a packet of a process target. For example, in the flow table 63 of FIG. 8, it is used as a match condition that the destination IP address of a packet of a forwarding target coincides with the subnetwork address of one of the subnetworks 5. Further, the process designated in each entry is to output a packet of a process target to a port directed toward the subnetwork 5 set in the match condition. Therefore, for example, from the relaying apparatus 80a (relaying apparatus ID=1), a packet destined for 10.0.10.0/24 is outputted to the port 2; a packet destined for 10.0.20.0/24 is outputted to the port 1; and a packet destined for 10.0.30.0/24 is outputted to the port 1. It is to be noted that FIG. 8 depicts an example of the flow table 63 generated where the network is formed in such a manner as depicted in FIG. 3 and besides the mobile terminal 10 is positioned in the home network.

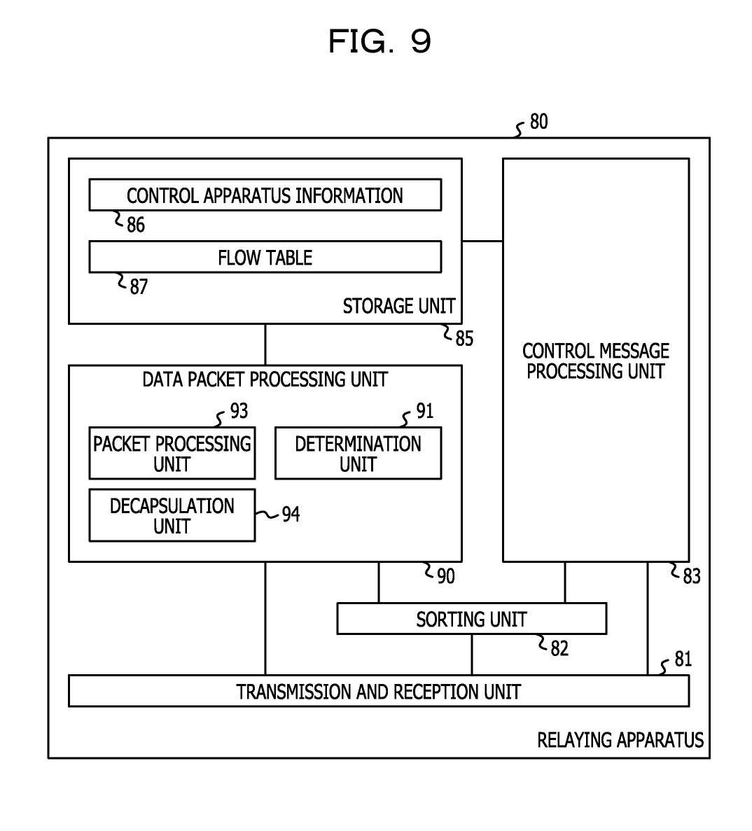

FIG. 9 is a block diagram depicting an example of a configuration of a relaying apparatus. The relaying apparatus depicted in FIG. 9 may be the relaying apparatus 80 described with reference to FIG. 2. The relaying apparatus 80 includes a transmission and reception unit 81, a sorting unit 82, a control message processing unit 83, a storage unit 85, and a data packet processing unit 90. The storage unit 85 stores control apparatus information 86 and a flow table 87 therein. The data packet processing unit 90 includes a determination unit 91, a packet processing unit 93, and a decapsulation unit 94.

The transmission and reception unit 81 transmits and receives a packet to and from a different apparatus. The sorting unit 82 outputs, when the packet received through the transmission and reception unit 81 is a data packet or a position registration request message, the received packet to the determination unit 91. On the other hand, if a control packet transmitted from the control apparatus 50 is inputted, then the sorting unit 82 outputs the inputted packet to the control message processing unit 83. The control message processing unit 83 performs a changing process of the flow table 87, a forwarding process for the packet and so forth in accordance with the control packet received from the control apparatus 50.

The determination unit 91 searches the flow table on the basis of header information of a packet to search for a match condition. The determination unit 91 outputs a packet, for which decapsulation is requested, to the decapsulation unit 94 together with information indicative of the substance of a process recorded in the entry that matches with the packet. However, with regard to a packet for which decapsulation is not requested, the determination unit 91 outputs information obtained from the flow table 87 to the packet processing unit 93 together with the packet of the process target.

The packet processing unit 93 performs, for a packet inputted thereto, a process designated by the information received from the determination unit 91. The decapsulation unit 94 performs decapsulation for the inputted packet and further performs a process designated by the information received from the determination unit 91.

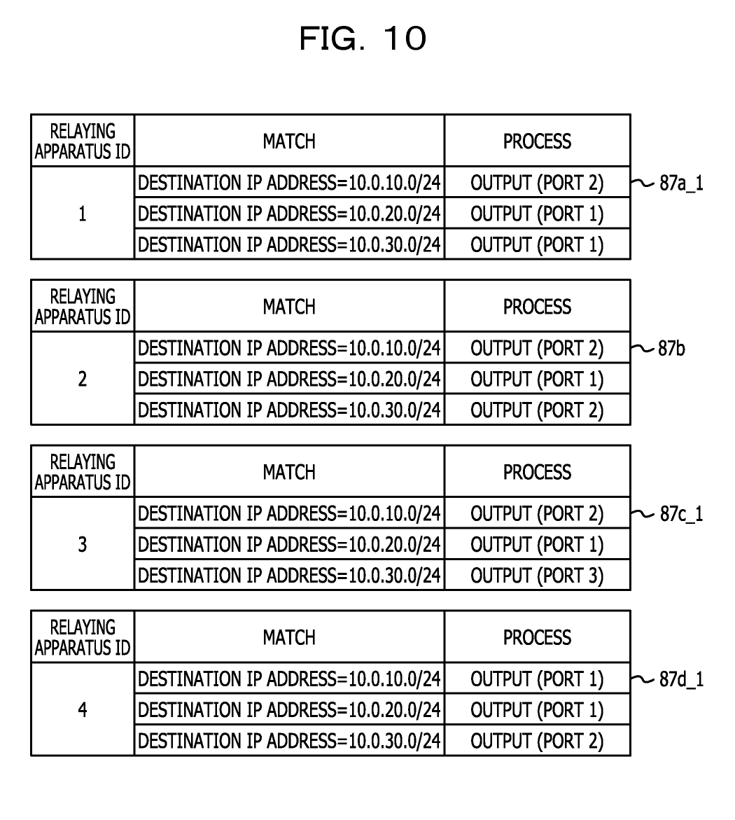

FIG. 10 is a view depicting an example of a flow table held by a relaying apparatus. The relaying apparatus described with reference to FIG. 10 may be the relaying apparatus 80 described with reference to FIG. 2, and the flow table depicted in FIG. 10 may be the flow table 87 depicted in FIG. 9. It is to be noted that, in the following description, in order to facilitate distinction of a table or the like included in an individual relaying apparatus 80, an alphabet allocated to a relaying apparatus 80 that is operating is added to a reference character. For example, a flow table 87a represents the flow table 87 included in the relaying apparatus 80a. Further, when the substance of the table varies as time passes, a numeral is sometimes added next to the underscore to indicate at which point of time the table belongs. Here, the flow table 87 held by each relaying apparatus 80 is coincident with information associated with the relaying apparatus ID of the relaying apparatus 80 in the flow table 63 depicted in FIG. 8. In particular, in a flow table 87a_1, the information of the relaying apparatus ID=1 (relaying apparatus 80a) in the flow table 63 (FIG. 8) is recorded.

Similarly, a flow table 87b in FIG. 10 is held by the relaying apparatus 80b and includes information of the relaying apparatus ID=2 (relaying apparatus 80b) in the flow table 63. A flow table 87c_1 is held by the relaying apparatus 80c and includes information of the relaying apparatus ID=3 (relaying apparatus 80c) in the flow table 63. Further, a flow table 87d_1 is held by the relaying apparatus 80d and includes information of the relaying apparatus ID=4 (relaying apparatus 80d) in the flow table 63.

The flow table 87 has processes recorded therein in an associated relationship with match conditions similarly to the flow table 63 held by the control apparatus 50. The determination unit 91 uses an entry, in which the match condition coincides with the match condition of the destination address of the packet and which has the greatest bit number, for determination of a process to be performed for the packet.

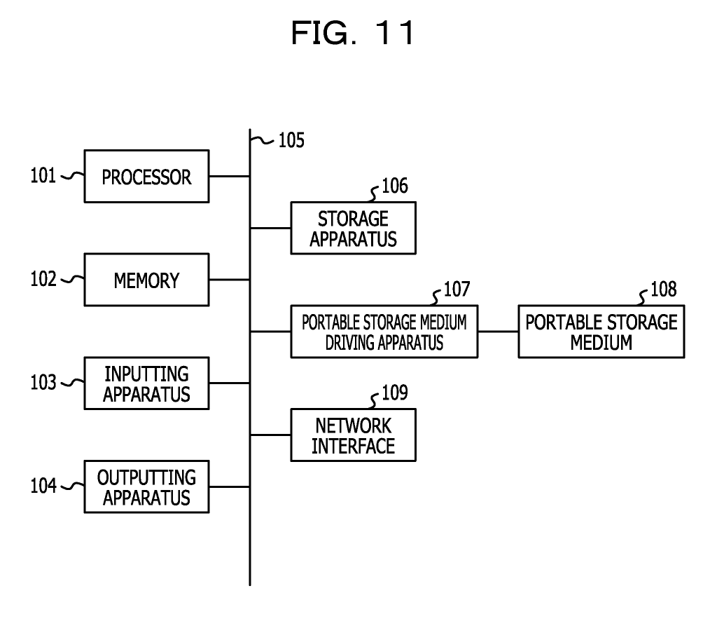

FIG. 11 is a block diagram depicting an example of a hardware configuration. All of the conversion apparatus 20, the control apparatus 50 and the relaying apparatus 80 can be configured to have the hardware configuration depicted in FIG. 11 and include a processor 101, a memory 102, a bus 105 and a network interface 109. Any of the conversion apparatus 20, the control apparatus 50 and the relaying apparatus 80 may further include one or more of an inputting apparatus 103, an outputting apparatus 104, a storage apparatus 106 and a portable storage device driving apparatus 107. The processor 101 is an arbitrary processing circuit including a central processing unit (CPU) and can execute a program stored in the memory 102 or the storage apparatus 106. The bus 105 couples the processor 101, the memory 102 and the network interface 109 to each other such that data can be communication between the processor 101, the memory 102 and the network interface 109.

The inputting apparatus 103 is an arbitrary apparatus used to input information such as a keyboard, and the outputting apparatus 104 is an arbitrary apparatus used to output data such as a display unit. The portable storage device driving apparatus 107 can output data in the memory 102 or the storage apparatus 106 to a portable storage device 108 and read out a program, data and so forth from the portable storage device 108. Here, the portable storage device 108 may be an arbitrary recording medium that can be carried and includes a compact disc recordable (CD-R) or a digital versatile disc recordable (DVD-R).

In the conversion apparatus 20, the processor 101 implements the packet identification unit 24, the packet processing unit 35 and the message processing unit 40. The memory 102 operates as the storage unit 30. The network interface 109 operates as the transmission and reception unit 21 and includes also ports.

In the control apparatus 50, the processor 101 implements the identification unit 54, the control message processing unit 55 and the setting request processing unit 70. The memory 102 operates as the storage unit 60. The network interface 109 operates as the transmission and reception unit 51.

In the relaying apparatus 80, the processor 101 implements the sorting unit 82, the control message processing unit 83 and the data packet processing unit 90. The memory 102 operates as the storage unit 85. The network interface 109 operates as the transmission and reception unit 81.

### First Embodiment

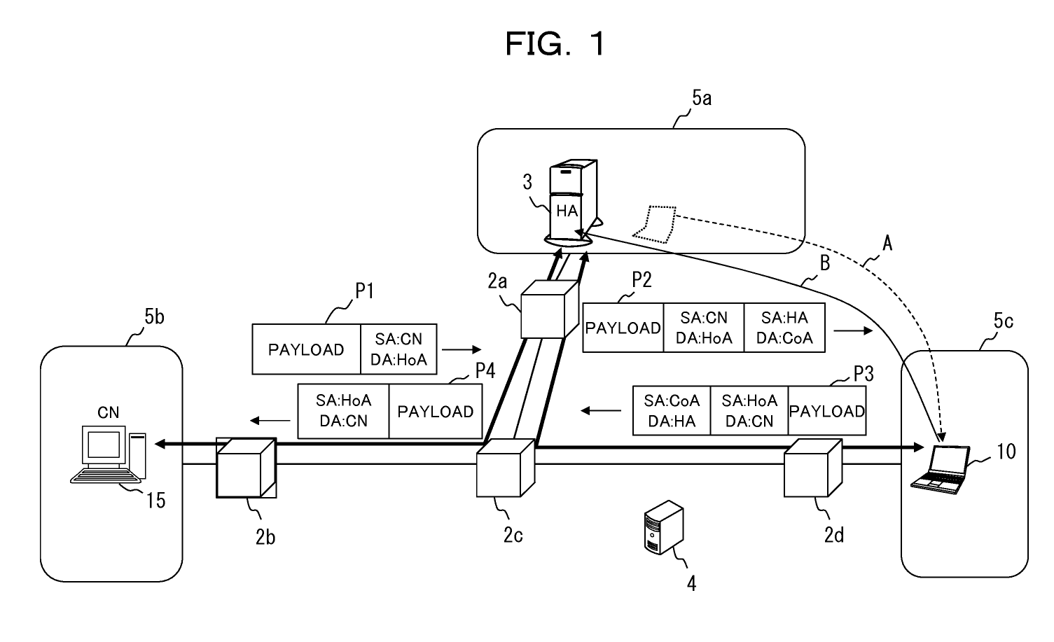

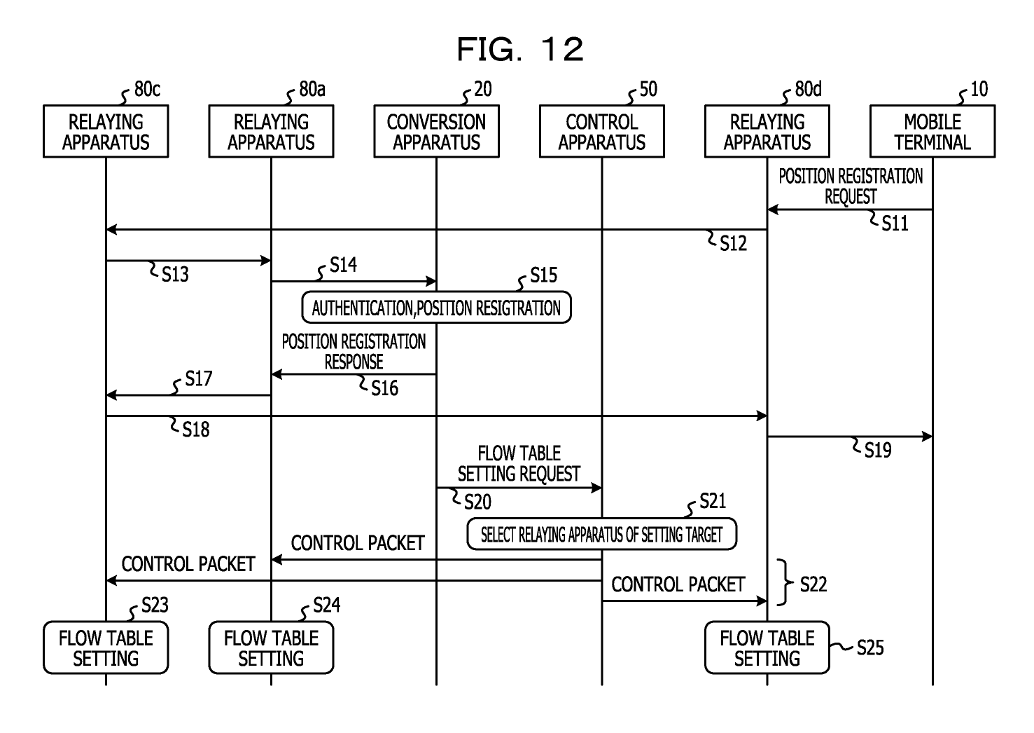

FIG. 12 is a sequence diagram depicting an example of processing performed when a mobile terminal moves. The mobile terminal described with reference to in FIG. 12 may be the mobile terminal 10 depicted in FIG. 1. At steps S11 to S19 in FIG. 12, a process relating to position registration of the mobile terminal 10 is performed, and at steps beginning with step S20, a changing process of the flow table 87 in the relaying apparatus 80 for transmitting a packet to the mobile terminal 10 after the movement is performed. In the following, an example of processing performed when the mobile terminal 10 moves from the subnetwork 5a to the subnetwork 5c under a situation that the control apparatus 50 retains the information illustrated in FIGS. 6 to 8. It is to be noted that FIG. 12 illustrates an example of the processing, and the processes at steps S20 to S25 may be performed in parallel to the processes at steps S16 to S19.

(1) Process for Position Registration

At step S11, the mobile terminal 10 detects that it has moved to the subnetwork 5c different from the home subnetwork thereof. For example, the mobile terminal 10 can detect the movement using a dynamic host configuration protocol (DHCP) message broadcasted by a DHCP server, a router advertisement message broadcasted by the relaying apparatus 80d or the like. Further, the mobile terminal 10 can detect that the mobile terminal 10 has moved also from the fact that the network address in an IP package transmitted to or received from an apparatus in the subnetwork 5c is different from the network address (10.0.10.0/24) in the home address. After detecting that the mobile terminal 10 has moved from the subnetwork 5a, the mobile terminal 10 acquires an IP address to be used as a care-of address. In the following example, as depicted in FIG. 3, it is assumed that the care-of address acquired by the mobile terminal 10 is 10.0.30.10. After acquiring the care-of address, the mobile terminal 10 transmits a position registration request message destined for the conversion apparatus 20. The position registration request message includes the home address (10.0.10.10) and the care-of address of the mobile terminal 10, authentication information and so forth. It is to be noted that, in the IP header of the position registration request message, the transmission source address is the care-of address of the mobile terminal 10 and the destination address is the address (10.0.10.1) of the conversion apparatus 20.

At step S12, a transmission and reception unit 81d of the relaying apparatus 80d receives and outputs the position registration request message to a sorting unit 82d. The sorting unit 82d outputs the position registration request message to a determination unit 91d. Since the destination address of the position registration request message is 10.0.10.1, the determination unit 91d selects the first entry in the flow table 87d_1 (FIG. 10). Since the process included in the first entry is to output from the port 1, the determination unit 91d outputs the substance of the process and the position registration request message to a packet processing unit 93d. The packet processing unit 93d designates the output port to the port 1 and outputs the packet inputted thereto from the determination unit 91d to the transmission and reception unit 81d. Then, the transmission and reception unit 81d outputs the position registration request message from the port 1 whereby the position registration request message is forwarded to the relaying apparatus 80c.

At step S13, the relaying apparatus 80c receives the position registration request message and performs a process similar to that performed by the relaying apparatus 80d. Therefore, the position registration request message is outputted from the port 2 of the relaying apparatus 80c in accordance with the first entry in the flow table 87c_1 (FIG. 10). Since the port 2 of the relaying apparatus 80c is coupled to the relaying apparatus 80a, the position registration request message is forwarded to the relaying apparatus 80a.

At step S14, the relaying apparatus 80a receives the position registration request message and performs a process similar to that performed by the relaying apparatus 80d. The position registration request message is outputted from the port 2 of the relaying apparatus 80a in accordance with the first entry in the flow table 87a_1 and forwarded to the conversion apparatus 20 in the subnetwork 5a.

At step S15, the reception unit 23 of the conversion apparatus 20 outputs the position registration request message to the packet identification unit 24. The packet identification unit 24 outputs the position registration request message to the detection unit 41. The detection unit 41 performs an authentication process and position registration using the information in the position registration request message.

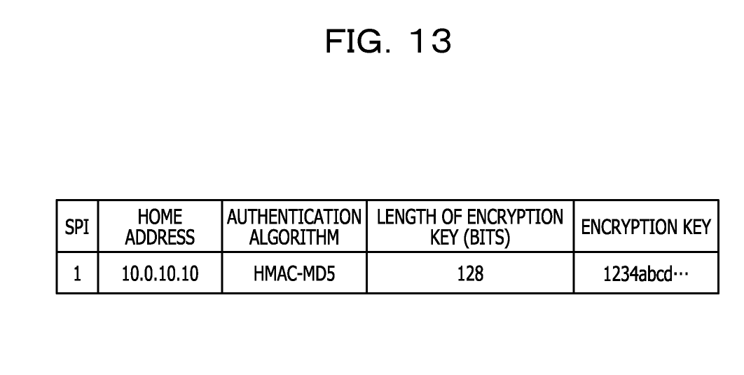

FIG. 13 is a view depicting an example of authentication information. The authentication information depicted in FIG. 13 may be the authentication information 31 depicted in FIG. 4. In the example of FIG. 13, the authentication information 31 includes a security parameter index (SPI), the home address of the mobile terminal 10, an authentication algorithm, a bit length of an encryption key, the encryption key and so forth. The SPI is an identifier regarding an authentication parameter set. The authentication algorithm is a kind of algorithm used for calculation of authentication information, and the encryption key is key data to be used to calculate authentication information using the authentication algorithm. The detection unit 41 performs an authentication process using the authentication information and the home address included in the position registration request message. Here, it is assumed that the detection unit 41 succeeds in the authentication process of the mobile terminal 10.

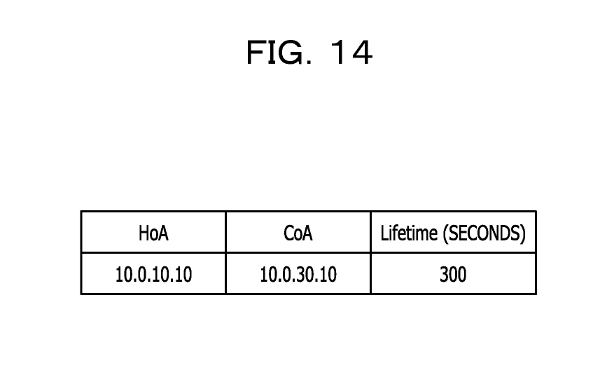

FIG. 14 is a view depicting an example of position registration information. The position registration information depicted in FIG. 14 may be the position registration information 32 depicted in FIG. 4. The position registration information 32 includes a care-of address (CoA) of the mobile terminal 10 and Lifetime in association with the home address (HoA) of the mobile terminal 10. If the detection unit 41 succeeds in the authentication of the mobile terminal 10, then the detection unit 41 records the home address included in the position registration request message and the care-of address in an associated relationship with each other in the position registration information 32 as depicted in FIG. 14. The Lifetime is a valid time period (seconds) of the information included in the entry. If a desired value of the Lifetime is included in the position registration request message, then the detection unit 41 sets the value of the Lifetime to a value lower than the desired value received from the mobile terminal 10. In the example of FIG. 14, the Lifetime is set to 300 seconds.

Step S16 of FIG. 12 indicates transmission of a position registration response message. After the position registration is completed, the detection unit 41 generates a position registration response message and transmits the position registration response message toward the mobile terminal 10 through the transmission unit 22. At this time, the destination of the position registration response message is set to the care-of address (10.0.30.10) of the mobile terminal 10. The position registration response message is forwarded from the conversion apparatus 20 to the relaying apparatus 80a.

At step S17, the process of the relaying apparatus 80a that receives the position registration response message is similar to that at step S14. Therefore, the position registration response message is outputted toward the relaying apparatus 80c from the port 1 of the relaying apparatus 80a in accordance with the flow table 87a_1. At step S18, also the relaying apparatus 80c performs a process similar to that at step S13. Therefore, the position registration response message is outputted from the port 3 of the relaying apparatus 80c toward the relaying apparatus 80d. At step S19, the relaying apparatus 80d performs a process similar to that at step S12 to forward the position registration response message to the mobile terminal 10 in the subnetwork 5c.

(2) Process for Update of the Flow Table

In the following, a selecting method of a relaying apparatus 80 that becomes a target for update of the flow table 87, an updating method of the flow table 87 and so forth are described with reference to the steps beginning with step S20 of FIG. 12.

At step S20, the detection unit 41 of the conversion apparatus 20 performs position registration regarding the mobile terminal 10 and thereby determines that a movement of the mobile terminal 10 is detected. The detection unit 41 notifies the setting requesting unit 42 that a movement of the mobile terminal 10 is detected. The setting requesting unit 42 generates a message (flow table setting request) for requesting the control apparatus 50 to perform rewriting of the flow table 87 held by one or more relaying apparatus 80 in the network in response to the movement of the mobile terminal 10. The flow table setting request includes the home subnetwork of the mobile terminal 10, and information usable to specify a subnetwork in which the mobile terminal 10 is positioned. In the following description, the subnetwork in which the mobile terminal 10 is positioned is sometimes referred to as “movement destination subnetwork.” The information to be used for the specification of the home subnetwork of the mobile terminal 10 may be the home address of the mobile terminal 10 or may be the subnetwork address of the subnetwork 5a that is the home network of the mobile terminal 10. Similarly, also the information to be used for the specification of the movement destination subnetwork may be the care-of address of the mobile terminal 10 or the subnetwork address of the subnetwork 5c that is the movement destination subnetwork. Note that it is assumed that, even if the flow table setting request includes the subnetwork address of the home subnetwork, the flow table setting request includes the home address of the mobile terminal 10.

Here, a case in which the home address is used as the information to be used for the specification of the home subnetwork and the care-of address is used as the information to be used for the specification of the movement destination subnetwork is taken as an example. Accordingly, the flow table setting request generated by the setting requesting unit 42 includes

the HoA of the mobile terminal 10: 10.0.10.10, and

the CoA of the mobile terminal 10: 10.0.30.10.

The setting requesting unit 42 transmits the generated flow table setting request to the control apparatus 50 through the transmission unit 22.

At step S21, the reception unit 53 of the control apparatus 50 outputs the flow table setting request to the identification unit 54. If the identification unit 54 determines that the packet inputted thereto is a flow table setting request, then the identification unit 54 outputs the flow table setting request to the extraction unit 71. The extraction unit 71 extracts, from the flow table setting request, information for specifying the home subnetwork and the movement destination subnetwork of the mobile terminal 10. Here, the extraction unit 71 extracts the home address and the care-of address of the mobile terminal 10 from the flow table setting request. The extraction unit 71 specifies from the extracted address that the home subnetwork address of the mobile terminal 10 is 10.0.10.0/24 and the address of the movement destination subnetwork is 10.0.30.0/24. In other words, the extraction unit 71 specifies that the home subnetwork of the mobile terminal 10 is the subnetwork 5a and that the movement destination subnetwork is the subnetwork 5c. It is to be noted that, when the extraction unit 71 specifies the home subnetwork and the movement destination subnetwork, the extraction unit 71 may suitably use the coupling information table 62 (FIG. 7) to specify the address of the subnetwork to which the extracted address belongs. The extraction unit 71 outputs the obtained subnetwork address to the selection unit 72.

The selection unit 72 uses the subnetwork address inputted thereto from the extraction unit 71 to search for the relaying apparatus 80 included in the route from the home subnetwork to the movement destination subnetwork of the mobile terminal 10. At this time, the selection unit 72 uses the topology information table 61 and the coupling information table 62 to specify the position of each relaying apparatus 80 in the network and a coupling relationship between the relaying apparatus 80. Here, the selection unit 72 uses the topology information table 61 (FIG. 6) and the coupling information table 62 (FIG. 7) to recognize that the network is such as depicted in FIG. 3. Accordingly, the selection unit 72 selects the relaying apparatus 80a, 80c, and 80d as a target to which a change of the flow table 87 is requested.

The generation unit 73 changes the flow table 63 such that, in each of the relaying apparatus 80 selected by the selection unit 72, the forwarding destination of a packet destined for the home address of the mobile terminal 10 becomes same as the output port for a packet destined for the movement destination subnetwork of the mobile terminal 10. Further, the generation unit 73 sets such that decapsulation of the packet received from the mobile terminal 10 is to be performed by the relaying apparatus 80 coupled to the movement destination subnetwork.

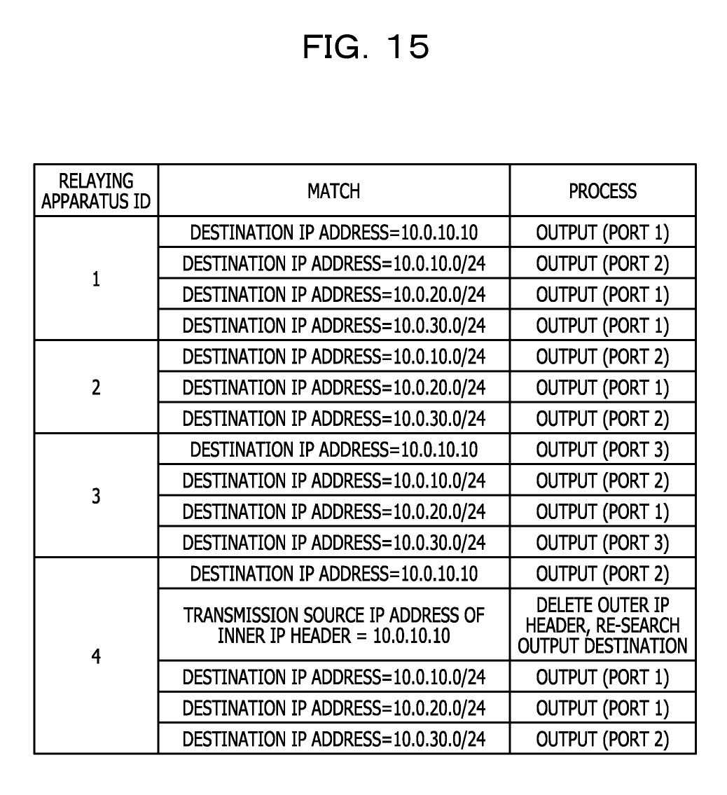

FIG. 15 is a view depicting an example of a change of a flow table. The flow table described with reference to FIG. 15 may be the flow table 63 depicted in FIG. 5. As depicted in FIG. 15, the selection unit 72 adds, to the match condition for the relaying apparatus 80a (relaying apparatus ID=1), a setting that the output port for a packet destined for the home address (10.0.10.10) of the mobile terminal 10 is the port 1. It is to be noted that, in the relaying apparatus 80a, also the output port for a packet destined for the subnetwork 5c is the port 1. Similarly, the generation unit 73 adds, to the match condition for the relaying apparatus 80c (relaying apparatus ID=3), that the output port for a packet destined for 10.0.10.10 that is the HoA of the mobile terminal 10 is the port 3. Further, the generation unit 73 adds, to the match condition for the relaying apparatus 80d (relaying apparatus ID=4), that the output port for a packet destined for 10.0.10.10 that is the HoA of the mobile terminal 10 is the port 1.

Here, when communicating with the communication apparatus 15, the mobile terminal 10 transmits an encapsulated packet because the mobile terminal 10 tries to transmit a packet through the conversion apparatus 20. Therefore, with regard to the relaying apparatus 80d, since the relaying apparatus 80d is coupled to the movement destination subnetwork, the generation unit 73 sets such that, after a packet received from the mobile terminal 10 is decapsulated, an output destination is searched out again from within the flow table 63. Accordingly, in the relaying apparatus ID=4 in FIG. 15, decapsulation and re-search of an output destination are recorded as processes for IPinIP encapsulated packet whose inner header designates that the transmission source is 10.0.10.10.

After the update of the flow table 63 is completed, the generation unit 73 generates a control packet for requesting an update of the flow table 87 to the relaying apparatus 80 associated with the relaying apparatus IDs including the updated entries. At this time, the generation unit 73 suitably uses the relaying apparatus information table 64.

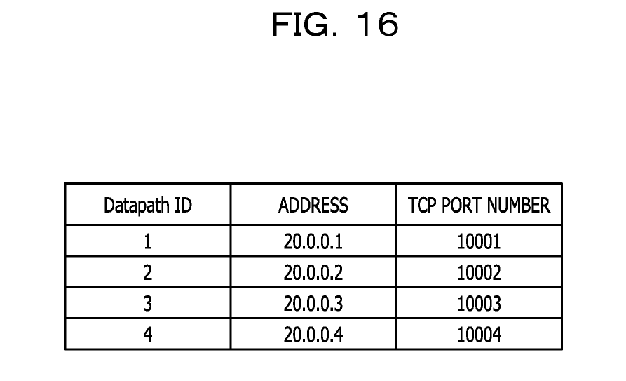

FIG. 16 is a view depicting an example of a relaying apparatus information table. The relaying apparatus information table depicted in FIG. 16 may be the relaying apparatus information table 64 depicted in FIG. 5. The relaying apparatus information table 64 includes a datapath ID, an address and a transmission control protocol (TCP) port number. The datapath ID is an identifier provided for each relaying apparatus 80 of a communication destination for identifying a controlling path. In the following description, it is assumed that the communication path between the control apparatus 50 and the relaying apparatus 80a is identified with the datapath ID=1. Similarly, it is assumed that, to the control apparatus 50, the datapath ID of the communication path from the relaying apparatus 80b is 2; the datapath ID of the communication path from the relaying apparatus 80c is 3; and the datapath ID of the communication path from the relaying apparatus 80d is 4. The address is an IP address allocated to the relaying apparatus 80 that uses a path specified by a datapath ID. Further, the TCP port number is a serial number of a TCP port used for communication with the relaying apparatus 80 specified with the datapath ID.

At step S22 of FIG. 12, the generation unit 73 transmits a control packet generated using the flow table 63 and the relaying apparatus information table 64 after updated to each of the relaying apparatus 80a, 80c, and 80d. The control packet transmitted to the relaying apparatus 80a includes information for requesting to add the substance of the entry added with regard to the relaying apparatus ID=1 to the flow table 87a. Similarly, the control packet destined for the relaying apparatus 80c includes information for requesting to add the substance of the entry added with regard to the relaying apparatus ID=3, and the control packet destined for the relaying apparatus 80d includes information for requesting to add the substance of the entry added with regard to the relaying apparatus ID=4. Where an OpenFlow is used between the control apparatus 50 and the relaying apparatus 80, a control packet can be transmitted as a Flow-Mod message to the relaying apparatus 80 of the notification destination.

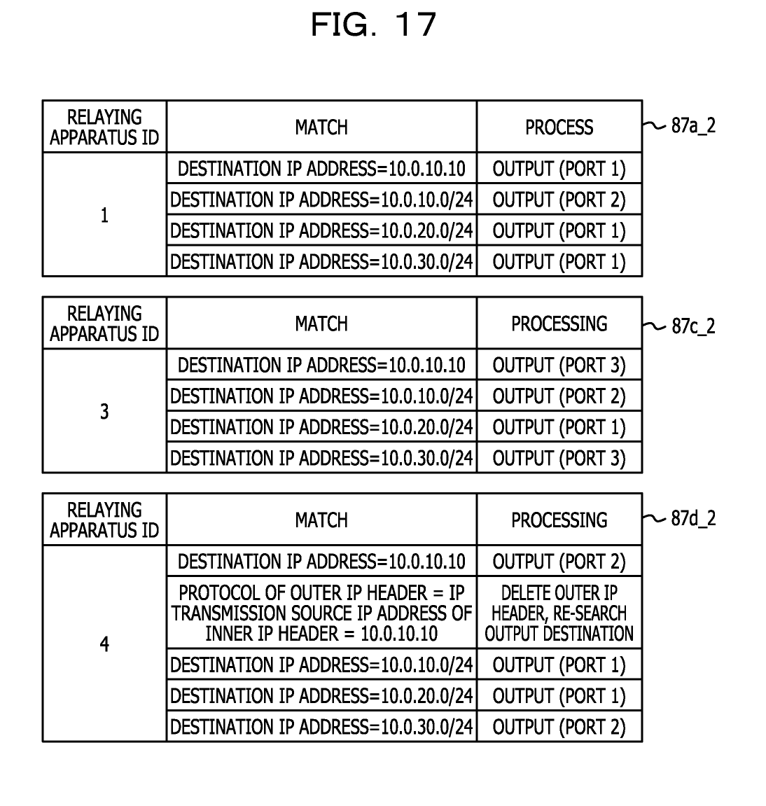

FIG. 17 is a view depicting an example of a flow table after updated. The flow table described with reference to FIG. 17 may be the flow table 87 depicted in FIG. 9. At step S23, the control message processing unit 83c of the relaying apparatus 80c acquires a control packet through the transmission and reception unit 81c and the sorting unit 82c. The control message processing unit 83c updates the flow table 87c_1 (FIG. 10) into a flow table 87c_2 depicted in FIG. 17 in accordance with the control packet.

Similarly, at step S24, the control message processing unit 83a of the relaying apparatus 80a updates the flow table 87a_1 (FIG. 10) into a flow table 87a_2 depicted in FIG. 17 using the control packet. Further, the control message processing unit 83d of the relaying apparatus 80d updates the flow table 87d_1 (FIG. 10) into a flow table 87d_2 depicted in FIG. 17 using the control packet (step S25).

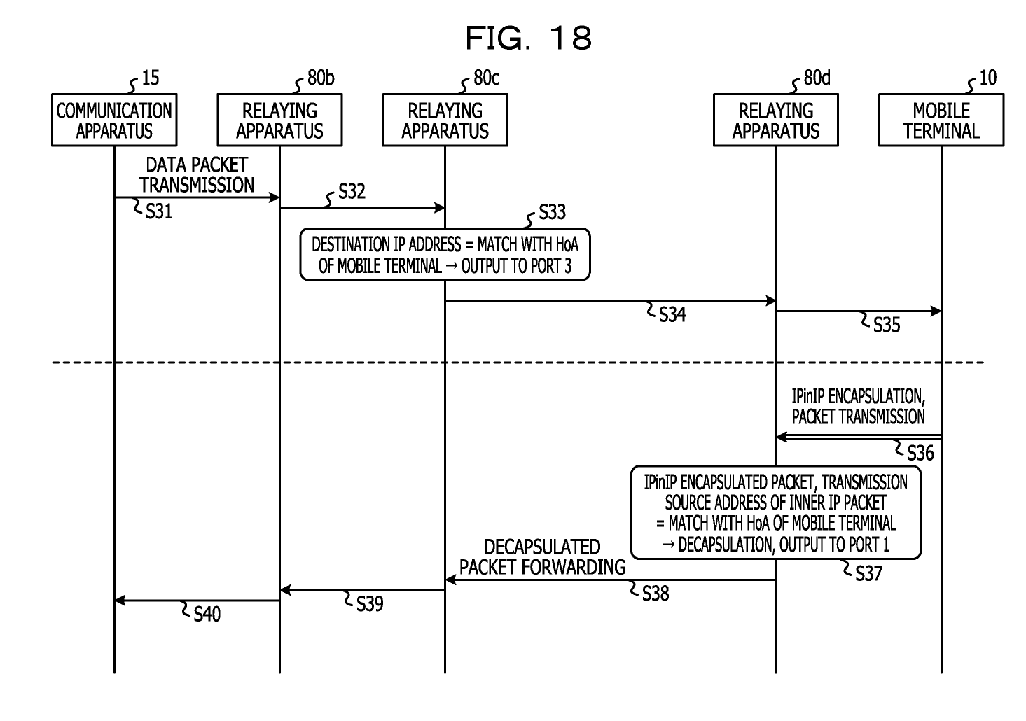

FIG. 18 is a sequence diagram depicting an example of processing performed upon transmission and reception of a packet to and from a mobile terminal. Steps S31 to S35 indicate an example of a forwarding process performed when a packet is transmitted from the communication apparatus 15 to the mobile terminal 10 after the flow table 87 is updated in a relaying apparatus 80. Meanwhile, steps S36 to S40 indicate an example of a forwarding process performed when a packet is transmitted from the mobile terminal 10 to the communication apparatus 15 after the flow table 87 in the relaying apparatus 80 is updated. It is to be noted that, while FIG. 18 depicts transmission of a packet from the mobile terminal 10 to the communication apparatus 15 at steps from step S36 onward, the order of the processes at steps S31 to S35 and the processes at steps S36 to S40 can be changed arbitrarily and they can be processed in parallel.

(3) Forwarding Process of a Packet from the Communication Apparatus 15 to the Mobile Terminal 10

Since the communication apparatus 15 generates a data packet destined for the mobile terminal 10 and transmits the generated data packet toward the mobile terminal 10, the relaying apparatus 80b receives the data packet (step S31). It is to be noted that the destination address of the data packet is the home address of the mobile terminal 10 (10.0.10.10).

Since the destination of the data packet is 10.0.10.10, the relaying apparatus 80b outputs the data packet from the port 2 thereof in accordance with the first entry of the flow table 87b (FIG. 10) (step S32). Accordingly, the data packet is forwarded to the relaying apparatus 80c.

The determination unit 91c of the relaying apparatus 80c acquires the data packet through the transmission and reception unit 81c and the sorting unit 82c. The determination unit 91c refers to the flow table 87c_2 (FIG. 17) in order to determine a process that is performed for the data packet. The determination unit 91c compares the destination address of the data packet and the match condition with each other and decides that the information in the first entry in the flow table 87c_2 can be used for a process of the data packet. The determination unit 91c outputs the data packet to the packet processing unit 93c together with the information in the first entry of the flow table 87c_2. In the first entry of the flow table 87c_2, it is set that a packet destined for the home address of the mobile terminal 10 is to be outputted from the port 3 (step S33). Therefore, the packet processing unit 93c outputs the data packet from the port 3 thereof. Therefore, the data packet is forwarded from the relaying apparatus 80c to the relaying apparatus 80d (step S34).

The relaying apparatus 80d performs a forwarding process using the flow table 87d_2 after updated (FIG. 17) similarly to the relaying apparatus 80c. Therefore, the determination unit 91d compares the destination address of the data packet and the match condition with each other and decides that the information in the first entry of the flow table 87d_2 can be used for a process of the data packet. In the first entry of the flow table 87d_2, it is set that a packet destined for the home address of the mobile terminal 10 is to be outputted from the port 2. Therefore, the packet processing unit 93d outputs the data packet from the port 2 thereof (step S35). Since the port 2 of the relaying apparatus 80d is coupled to the subnetwork 5c, the data packet is forwarded from the relaying apparatus 80d to the mobile terminal 10.

In this manner, since the flow table 87 of each relaying apparatus 80 in the route from the home subnetwork to the movement destination subnetwork of the mobile terminal 10 is updated, a data packet transmitted from the communication apparatus 15 and destined for the mobile terminal 10 is forwarded without being encapsulated. Therefore, in comparison with an alternative case in which a data packet is forwarded after encapsulated, the total amount of information to be communicated in the network can be reduced without changing the data amount to be communicated. Further, when a data packet is forwarded from the communication apparatus 15 to the mobile terminal 10, the data packet does not pass through the conversion apparatus 20. Therefore, the communication method according to the first embodiment is effective also in reduction of the length of the route and reduction of the delay time.

(4) Forwarding Process of a Packet from the Mobile Terminal 10 to the Communication Apparatus 15

Now, transmission of a packet from the mobile terminal 10 is described. Since the mobile terminal 10 is positioned in the movement destination subnetwork, at an outer side of a packet including data destined for the communication apparatus 15, an outer header for forwarding the packet to the conversion apparatus 20 is added. Accordingly, the following addresses are included in a packet transmitted from the mobile terminal 10:

Destination address of the outer header: 10.0.10.1 (conversion apparatus 20)

Transmission source address of the outer header: 10.0.30.10 (CoA)

Destination address of the inner header: 10.0.20.20 (communication apparatus 15)

Transmission source address of the inner header: 10.0.10.10 (HoA)

Since the mobile terminal 10 transmits the generated packet toward the conversion apparatus 20, the packet that is in an encapsulated form is received by the relaying apparatus 80d (step S36).

The determination unit 91d of the relaying apparatus 80d acquires the packet through the transmission and reception unit 81d and the sorting unit 82d. Since the inputted packet is in an encapsulated form and the transmission source address of the inner header is the home address of the mobile terminal 10, the determination unit 91d determines that the second entry of the flow table 87d_2 (FIG. 17) can be applied. The determination unit 91d outputs the encapsulated packet and the information of the second entry of the flow table 87d_2 to the decapsulation unit 94d. The decapsulation unit 94d determines that it is requested to perform decapsulation of the packet and re-search the forwarding destination of the packet after the decapsulation from the flow table 87d_2. Therefore, the decapsulation unit 94d decapsulates the packet on the basis of the inputted information. Further, the decapsulation unit 94d uses the destination address of the data packet after the decapsulation to search the flow table 87d_2. Since the destination address of the packet after the decapsulation is 10.0.20.20 (communication apparatus 15), the decapsulation unit 94d determines to output the data packet after the decapsulation from the port 1 thereof on the basis of the fourth entry of the flow table 87d_2 (step S37). Since the data packet after the decapsulation is outputted from the port 1, the data packet is forwarded from the relaying apparatus 80d to the relaying apparatus 80c (step S38).

The relaying apparatus 80c performs a forwarding process using the flow table 87c_2 (FIG. 17) after updated similarly to the relaying apparatus 80d. Therefore, a process for the data packet is performed using the information in the third entry of the flow table 87c_2. In the third entry of the flow table 87d_2, it is set that a packet destined for an apparatus in the subnetwork 5b is to be outputted from the port 1. Therefore, the packet processing unit 93d outputs the data packet from the port 1 thereof (step S39). Since the port 1 of the relaying apparatus 80c is coupled to the relaying apparatus 80b, the data packet is forwarded from the relaying apparatus 80c to the relaying apparatus 80b.

Since the destination of the data packet is 10.0.20.20, the relaying apparatus 80b outputs the data packet from the port 1 thereof in accordance with the second entry of the flow table 87b (FIG. 10) (step S40). Accordingly, the data packet is forwarded to the communication apparatus 15.

In this manner, in the first embodiment, a relaying apparatus 80 coupled to the movement destination subnetwork of the mobile terminal 10 decapsulates a packet transmitted thereto from the mobile terminal 10. In other words, in a route beginning with the relaying apparatus 80 that performs decapsulation, a data packet destined for the communication apparatus 15 is forwarded without being encapsulated. Therefore, in comparison with an alternative case in which a data packet is forwarded in an encapsulated form, the total amount of information to be communicated in the network can be reduced without changing the data amount to be communicated. Further, when a data packet is forwarded from the mobile terminal 10 to the communication apparatus 15, the data packet does not pass the conversion apparatus 20. Therefore, the communication method according to the first embodiment is effective also in reduction of the length of the route and reduction of the delay time.

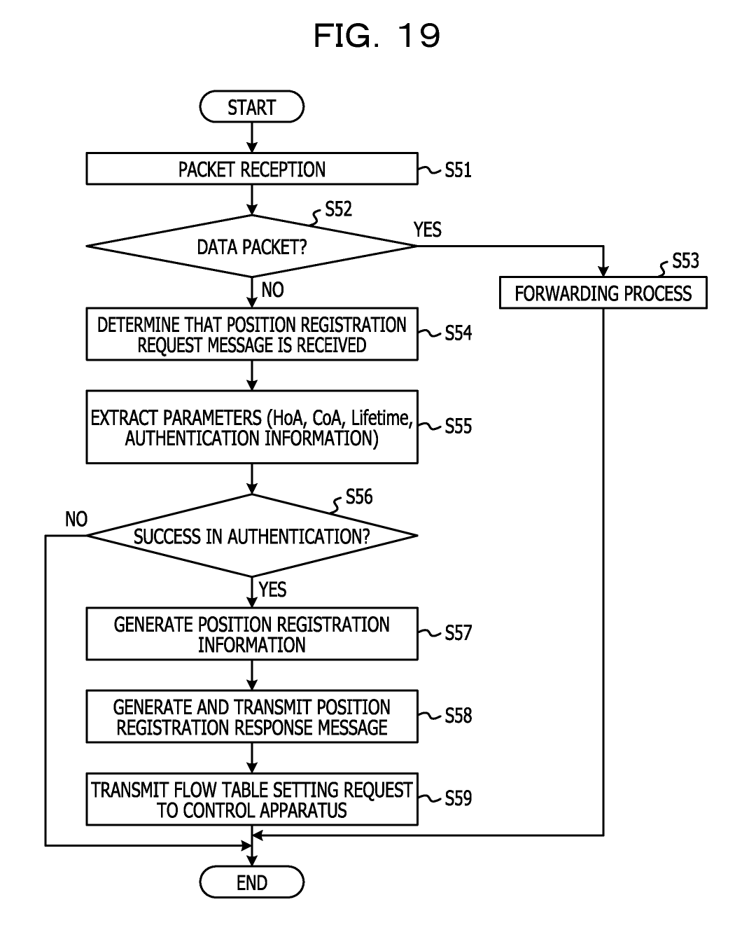

FIG. 19 is a flow chart illustrating an example of processing of a conversion apparatus. The conversion apparatus described with reference to FIG. 19 may be the conversion apparatus 20 depicted in FIG. 2. It is to be noted that the order of steps S57 to S59 can be changed arbitrarily. When the reception unit 23 receives a packet forwarded from the relaying apparatus 80, the packet identification unit 24 decides whether the received packet is a data packet (steps S51 and S52). If the received packet is a data packet, then the forwarding processing unit 36 determines one of the encapsulation unit 37 and the decapsulation unit 38 as an output destination of the packet in response to the destination of the packet (Yes at step S52). The encapsulation unit 37 encapsulates and forwards the packet destined for the mobile terminal 10. On the other hand, the decapsulation unit 38 decapsulates and forwards the packet destined for the communication apparatus 15 transmitted thereto from the mobile terminal 10 in the movement destination subnetwork (step S53).

If the received packet is not a data packet, then the detection unit 41 decides that a position registration request message is received and extracts such parameters as the HoA, CoA, Lifetime and authentication information from within the position registration request message (No at step S52, and steps S54 and S55). The detection unit 41 performs an authentication process and then, if failing in the authentication, ends the processing (No at step S56). On the other hand, if the authentication of the mobile terminal 10 is performed successfully, then the detection unit 41 performs position registration of the mobile terminal 10 and transmits a position registration response message to the mobile terminal 10 (Yes at step S56, and steps S57 and S58). Further, the setting requesting unit 42 transmits a flow table setting request to the control apparatus 50 (step S59).

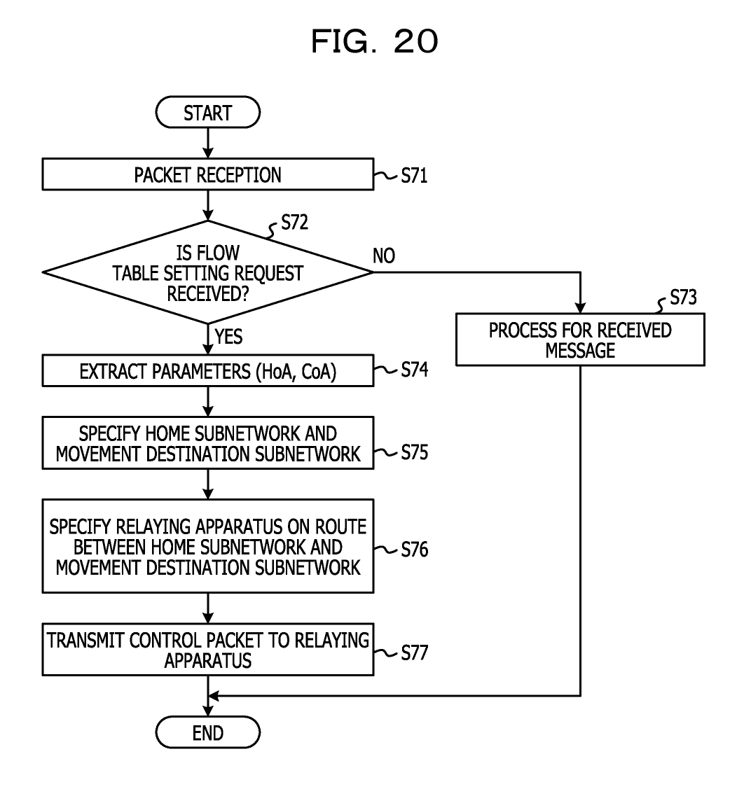

FIG. 20 is a flow chart illustrating an example of processing of a control apparatus. The control apparatus described with reference to FIG. 20 may be the control apparatus 50 depicted in FIG. 2. If the control apparatus 50 receives a packet, then the identification unit 54 determines whether a flow table setting request is received (steps S71 and S72). The identification unit 54 outputs a packet other than the flow table setting request to the control message processing unit 55, and the control message processing unit 55 processes the packet inputted thereto (No at step S72, and step S73).

On the other hand, if the packet received by the control apparatus 50 is a flow table setting request, then the extraction unit 71 extracts the home address and the care-of address of the mobile terminal 10 from within the flow table setting request (Yes at step S72, and step S74). The extraction unit 71 specifies the home subnetwork and the movement destination subnetwork of the mobile terminal 10 from the extracted address (step S75). The selection unit 72 specifies the relaying apparatus on the route from the home subnetwork to the movement destination subnetwork of the mobile terminal 10 (step S76). The generation unit 73 transmits a control packet for requesting setting update of the flow table 87 to the specified relaying apparatus 80 in accordance with the update substance of the flow table 63 (step S77).

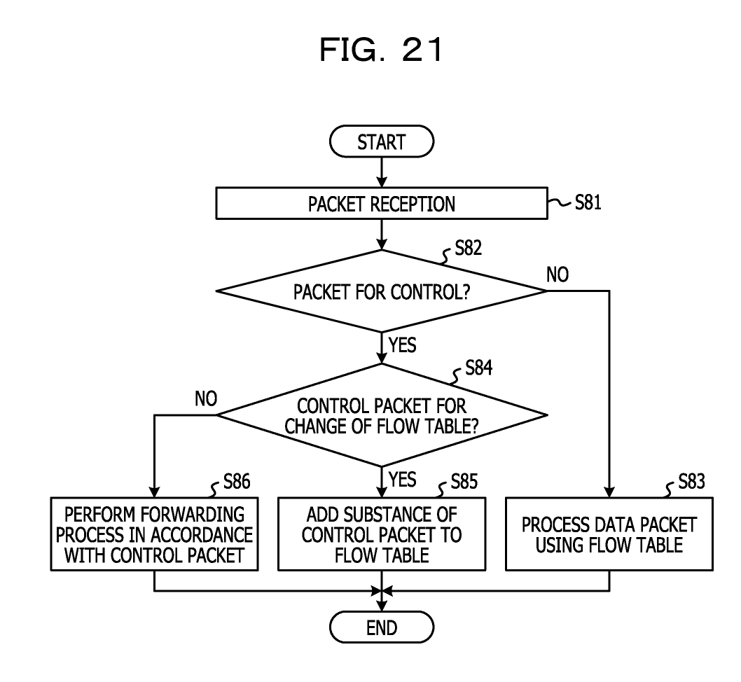

FIG. 21 is a flow chart illustrating an example of processing of a relaying apparatus. The relaying apparatus described with reference to FIG. 21 may be the relaying apparatus 80 described with reference to FIG. 2. If the relaying apparatus 80 receives a packet, then the sorting unit 82 decides whether the received packet includes information for control by the relaying apparatus 80 (steps S81 and S82). If the received packet does not include control information, then since the received packet is one of a data packet and a position registration request message, a forwarding process of the received packet by the data packet processing unit 90 is performed (No at step S82, and step S83). If the received packet is a control packet, then the control message processing unit 83 decides whether the received packet is a control packet that requests update of the flow table 87 (Yes at step S82, and step S84). If the received packet is a control packet that requests update of the flow table 87, the control message processing unit 83 adds the substance conveyed thereto by the control packet to the flow table 87 (Yes at step S84, and step S85). On the other hand, if the received packet is not a control packet that requests update of the flow table 87, then the control message processing unit 83 performs a forwarding process and so forth of the packet on the basis of the substance conveyed thereto by the received packet (step S86).

In this manner, with the method according to the first embodiment, after the mobile terminal 10 moves, the control apparatus 50 changes a setting of the relaying apparatus 80 in the route from the conversion apparatus 20 to the mobile terminal 10. Therefore, even if a packet transmitted from the communication apparatus 15 toward the mobile terminal 10 is not in an encapsulated form, the packet is transmitted to the mobile terminal 10. Also a packet transmitted from the mobile terminal 10 is decapsulated by the relaying apparatus 80 that is coupled to the movement destination subnetwork and then forwarded to the communication apparatus 15. Therefore, the number of links through which an encapsulated packet is communicated is minimized. Accordingly, the amount of information of a header to be used for forwarding from within information communicated through the network can be reduced, and the communication can be streamlined.

### Second Embodiment

A second embodiment to be described below is directed to an example wherein, after detecting that communication with a mobile terminal is started, a conversion apparatus changes a flow table of a relaying apparatus on a route from the conversion apparatus to a movement destination subnetwork. It is to be noted that, also in the second embodiment, a position registration process involved in a movement of the mobile terminal is performed in a similar manner as in the processes at steps S11 to S19 of FIG. 12.

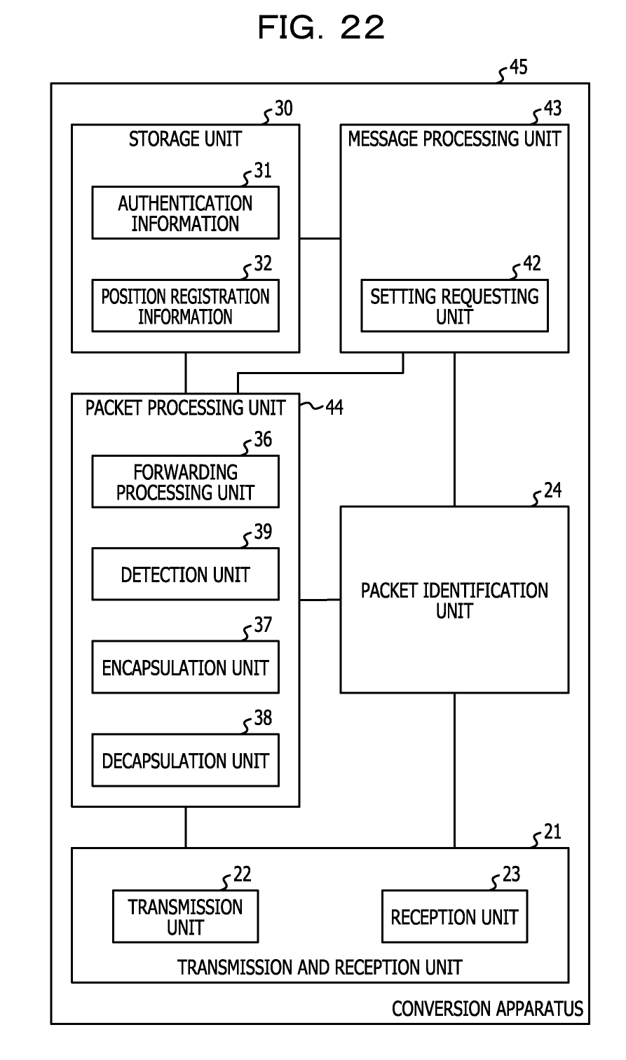

FIG. 22 is a block diagram depicting an example of a configuration of a conversion apparatus according to a second embodiment. A conversion apparatus 45 includes a transmission and reception unit 21, a packet identification unit 24, a storage unit 30, a message processing unit 43 and a packet processing unit 44. The message processing unit 43 includes a setting requesting unit 42. The packet processing unit 44 includes a forwarding processing unit 36, an encapsulation unit 37, a decapsulation unit 38 and a detection unit 39. The processes performed by the transmission and reception unit 21, the packet identification unit 24, the storage unit 30, the forwarding processing unit 36, the encapsulation unit 37 and the decapsulation unit 38 are similar to those in the conversion apparatus 20 of the first embodiment. Note that it is assumed that, in the second embodiment, position registration and authentication processes are performed by the message processing unit 43.

The detection unit 39 detects starting of communication of the mobile terminal 10 if one of the destination of a packet outputted from the forwarding processing unit 36 to the encapsulation unit 37 or the transmission source of a packet outputted from the forwarding processing unit 36 to the decapsulation unit 38 is the mobile terminal 10 after the position registration. After starting of communication is detected, the detection unit 39 notifies the setting requesting unit 42 of the starting of communication. The setting requesting unit 42 generates a flow table setting request on the basis of the notification from the detection unit 39 and transmits the flow table setting request to the control apparatus 50 through a transmission unit 22.

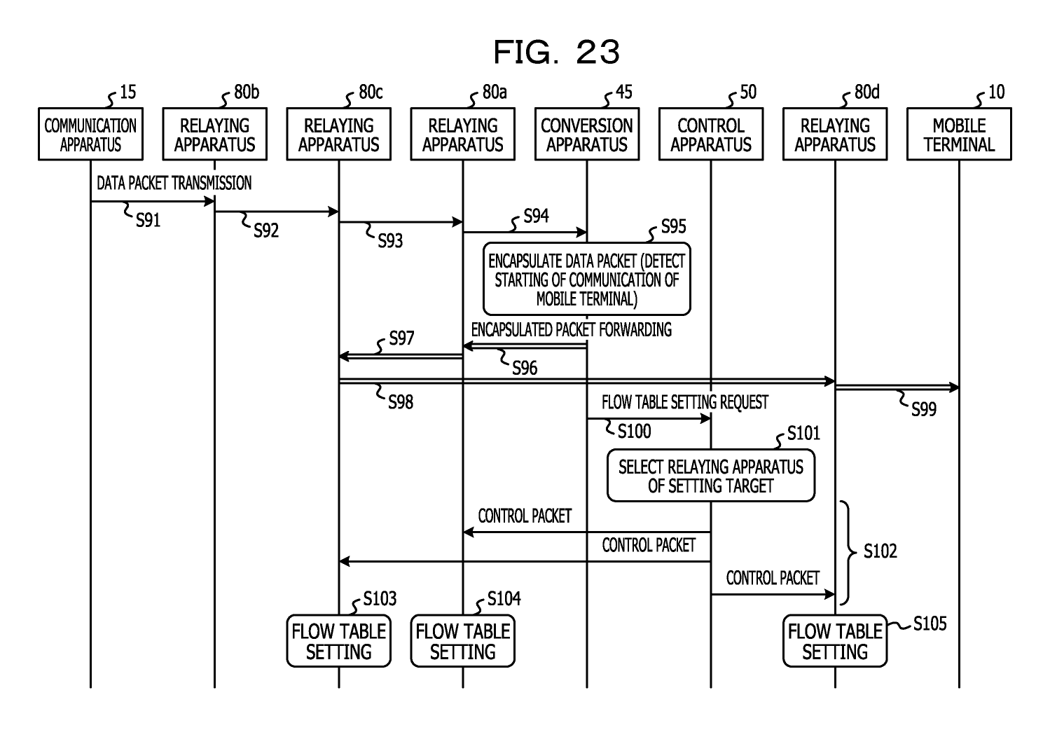

FIG. 23 is a sequence diagram depicting an example of processing performed when a flow table is updated using a transmission process of a packet destined for a mobile terminal as a trigger. It is assumed that, in the description given with reference to FIG. 23, the flow table 87 of each relaying apparatus 80 in the network is such as depicted in FIG. 10 and the flow table 63 of the control apparatus 50 is such as depicted in FIG. 8 when the data packet destined for the mobile terminal 10 is transmitted.

If the communication apparatus 15 transmits a data packet destined for the mobile terminal 10 after the position registration process of the mobile terminal 10, then the relaying apparatus 80b receives the data packet (step S91). Here, since the destination of the data packet is set to the home address of the mobile terminal 10, the relaying apparatus 80b outputs the data packet from the port 2 thereof using the flow table 87b (FIG. 10). Therefore, the data packet is forwarded from the relaying apparatus 80b to the relaying apparatus 80c (step S92). When receiving the data packet destined for the mobile terminal 10, the relaying apparatus 80c outputs the data packet from the port 2 thereof in accordance with the flow table 87c_1 (FIG. 10). Therefore, the data packet is forwarded from the relaying apparatus 80c to the relaying apparatus 80a (step S93). The relaying apparatus 80a receives the data packet destined for the mobile terminal 10 and outputs the data packet from the port 2 thereof in accordance with the flow table 87a_1 (FIG. 10). Therefore, the data packet is forwarded to the conversion apparatus 45 (step S94).

The forwarding processing unit 36 in the conversion apparatus 45 acquires the data packet destined for the mobile terminal 10 through a reception unit 23 and the packet identification unit 24. The forwarding processing unit 36 outputs the data packet to the encapsulation unit 37 because the destination of the data packet is the mobile terminal 10. The encapsulation unit 37 acquires the care-of address (CoA) allocated to the mobile terminal 10, which is the destination of the data packet, from the position registration information 32 (FIG. 14). The encapsulation unit 37 encapsulates the data packet using the acquired care-of address. Therefore, the destination address in the outer header of the data packet after the encapsulation is the care-of address (10.0.30.10) of the mobile terminal 10. On the other hand, since the encapsulation of the data packet is performed, the detection unit 39 detects starting of communication with the mobile terminal 10 that resides in a different subnetwork (step S95). The encapsulation unit 37 transmits the data packet after the encapsulation through the transmission unit 22. By this process, the data packet after the encapsulation is forwarded to the relaying apparatus 80a (step S96). In FIG. 23, the forwarding process of the encapsulated packet is indicated by a double line arrow mark.

Since the destination of the outer header of the data packet after the encapsulation is the care-of address of the mobile terminal 10, the relaying apparatus 80a applies the process for a packet destined for an apparatus in the subnetwork 5c using the flow table 87a_1. Since the relaying apparatus 80a outputs the data packet after the encapsulation from the port 1 thereof, the encapsulated data packet is forwarded to the relaying apparatus 80c (step S97). Also, since the relaying apparatus 80c processes the data packet after the encapsulation similarly to the relaying apparatus 80a using the flow table 87c_1, the encapsulated data packet is forwarded to the relaying apparatus 80d (step S98). The relaying apparatus 80d forwards the data packet after the encapsulation to the mobile terminal 10 in accordance with the flow table 87d_1 (step S99). Therefore, the mobile terminal 10 can acquire the data destined for the mobile terminal 10 from the payload of the packet obtained by decapsulation of the received packet.

At step S100, the detection unit 39 in the conversion apparatus 45 notifies the setting requesting unit 42 of starting of communication with the mobile terminal 10. The setting requesting unit 42 generates a flow table setting request in order to request the control apparatus 50 to perform rewriting of the flow table 87 held by one or more ones of the relaying apparatus 80 in the network in accordance with the request of the detection unit 39. The information factors included in the flow table setting request are similar to those in the first embodiment. The setting requesting unit 42 transmits the flow table setting request to the control apparatus 50 through the transmission unit 22.

The processes at steps S101 to S105 of FIG. 23 are similar to those at steps S21 to S25 described hereinabove with reference to FIG. 12, respectively. Therefore, using it as a trigger that a packet is transmitted from the communication apparatus 15 to the mobile terminal 10 whose position is registered already, the flow tables 87 of the relaying apparatus 80 included in the route from the conversion apparatus 45 to the movement destination subnetwork are updated. Further, transmission and reception of a packet after the flow tables 87 in the relaying apparatus 80 are updated are such as described hereinabove with reference to FIG. 18.

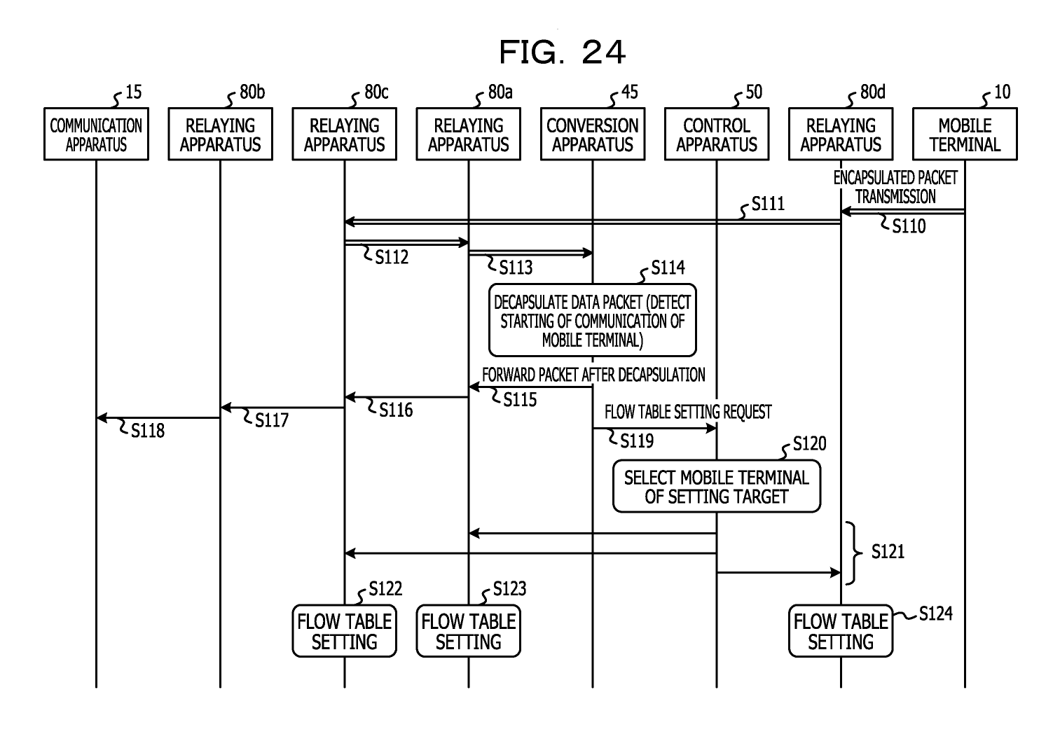

FIG. 24 is a sequence diagram depicting an example of processing performed when a flow table is updated using a transmission process of a packet from a mobile terminal as a trigger. Also in FIG. 24, the forwarding process of an encapsulated packet is indicated by a double line arrow mark.

It is assumed that, at step S110, after the position registration process of the mobile terminal 10, the mobile terminal 10 generates a packet by adding an outer header destined for the conversion apparatus 45 to the data packet destined for the communication apparatus 15 and transmits the generated packet. It is to be noted that the information of the addresses in the packet generated by the mobile terminal 10 is such as described just below:

Destination address of the outer header: 10.0.10.1 (conversion apparatus 45)

Transmission source address of the outer header: 10.0.30.10 (CoA)

Destination address of the inner header: 10.0.20.20 (communication apparatus 15)

Transmission source address of the inner header: 10.0.10.10 (HoA)

Since the mobile terminal 10 transmits the generated packet toward the conversion apparatus 45, the packet that is in an encapsulated form is received by the relaying apparatus 80d.

Since the destination of the outer header of the received packet is the address of the conversion apparatus 45, the relaying apparatus 80d applies a process for a packet destined for an apparatus in the subnetwork 5a using the flow table 87d_1. The relaying apparatus 80d outputs the received packet from the port 1 thereof to forward the received packet to the relaying apparatus 80c (step S111). Also the relaying apparatus 80c processes the received packet similarly to the relaying apparatus 80d using the flow table 87c_1, and therefore, the packet in an encapsulated form is forwarded to the relaying apparatus 80a (step S112). The relaying apparatus 80a forwards the received packet to the conversion apparatus 45 in accordance with the flow table 87a_1 (step S113).

The forwarding processing unit 36 in the conversion apparatus 45 acquires the data packet through the reception unit 23 and the packet identification unit 24. The forwarding processing unit 36 outputs the acquired packet to the decapsulation unit 38 in order to remove the outer header destined for the conversion apparatus 45 from the packet. The decapsulation unit 38 decapsulates the packet inputted thereto. Further, the decapsulation unit 38 refers to the position registration information 32 using the transmission source address of the inner IP header as a key to confirm that position registration of the mobile terminal 10 is performed. If the position registration is performed, then it is decided that the detection unit 39 detects starting of communication with the mobile terminal 10 (step S114). The decapsulation unit 38 transmits the data packet after the decapsulation through the transmission unit 22. By this process, the data packet after the decapsulation is forwarded to the relaying apparatus 80a (step S115). It is to be noted that, in the data packet after the decapsulation, the destination address is the IP address of the communication apparatus 15.

The relaying apparatus 80a outputs the data packet from the port 1 thereof using the flow table 87a_1 to forward the data packet to the relaying apparatus 80c (step S116). The relaying apparatus 80c receives the data packet destined for the communication apparatus 15 and outputs the data packet from the port 1 thereof in accordance with the flow table 87c_1 to forward the data packet to the relaying apparatus 80b (step S117). The relaying apparatus 80b receives the data packet and outputs the data packet from the port 1 thereof in accordance with the flow table 87b to forward the data packet to the communication apparatus 15 (step S118).

At step S119, the detection unit 39 notifies the setting requesting unit 42 of the starting of communication with the mobile terminal 10. The setting requesting unit 42 generates a flow table setting request in response to the request of the detection unit 39 and transmits the flow table setting request to the control apparatus 50 through the transmission unit 22.

The processes at steps S120 to S124 in FIG. 24 are similar to those at steps S21 to S25 described hereinabove with reference to FIG. 12, respectively. Therefore, using it as a trigger that the mobile terminal 10 whose position registration is completed transmits a packet to a different apparatus, the flow tables 87 of the relaying apparatus 80 included in the route from the conversion apparatus 45 to the movement destination subnetwork are updated. Further, transmission and reception of a packet after the flow tables 87 in the relaying apparatus 80 are updated are such as described hereinabove with reference to FIG. 18.

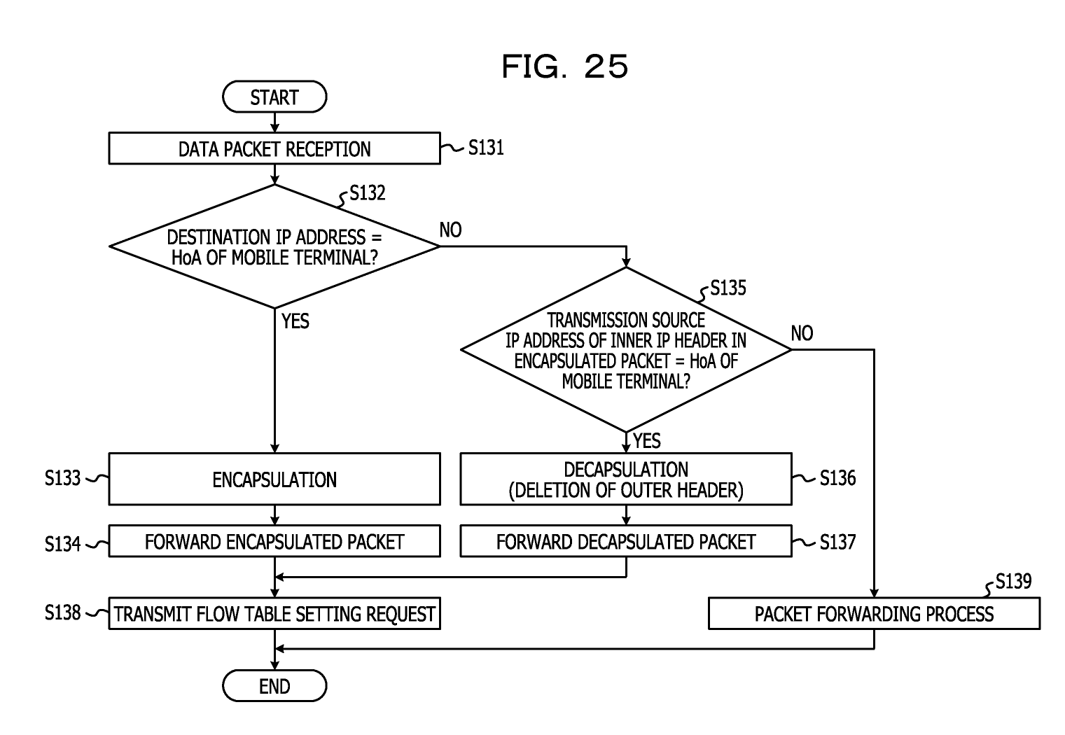

FIG. 25 is a flow chart illustrating an example of processing of a conversion apparatus. The conversion apparatus described with reference to FIG. 25 may be the conversion apparatus 45 depicted in FIG. 22. When the conversion apparatus 45 receives a data packet, the forwarding processing unit 36 acquires the data packet through the reception unit 23 and the packet identification unit 24 (step S131). The forwarding processing unit 36 decides whether the destination IP address of the data packet is the home address of the mobile terminal 10 (step S132). When the destination IP address of the data packet is the home address of the mobile terminal 10, the encapsulation unit 37 encapsulates and then forwards the data packet (Yes at step S132, and steps S133 and 134). On the other hand, when the destination address of the data packet is not the HoA of the mobile terminal 10, the forwarding processing unit 36 decides whether the data packet is an encapsulated packet transmitted from the mobile terminal 10 (No at step S132, and step S135). It is to be noted that, in an encapsulated packet transmitted from the mobile terminal 10, the transmission source IP address in the inner header is set to the home address of the mobile terminal 10. If the data packet is an encapsulated packet transmitted from the mobile terminal 10, then the decapsulation unit 38 decapsulates the data packet and then forwards the decapsulated data packet (Yes at step S135, and steps S136 and S137). After the process at step S134 or step S137 is performed, the setting requesting unit 42 transmits a flow table setting request toward the control apparatus 50 (step S138). On the other hand, if it is decided at step S135 that the data packet is not an encapsulated packet transmitted from the mobile terminal 10, then the forwarding processing unit 36 performs a forwarding process in accordance with the destination of the data packet (step S139).

If the second embodiment is applied, then even if the mobile terminal 10 moves from the home subnetwork, the changing process of the flow table 87 is not performed until communication is started. Therefore, where the mobile terminal 10 frequently moves between subnetworks and besides the possibility that the mobile terminal 10 may not perform communication in the subnetwork of the destination of the movement is high, a useless setting process can be omitted.

### Third Embodiment

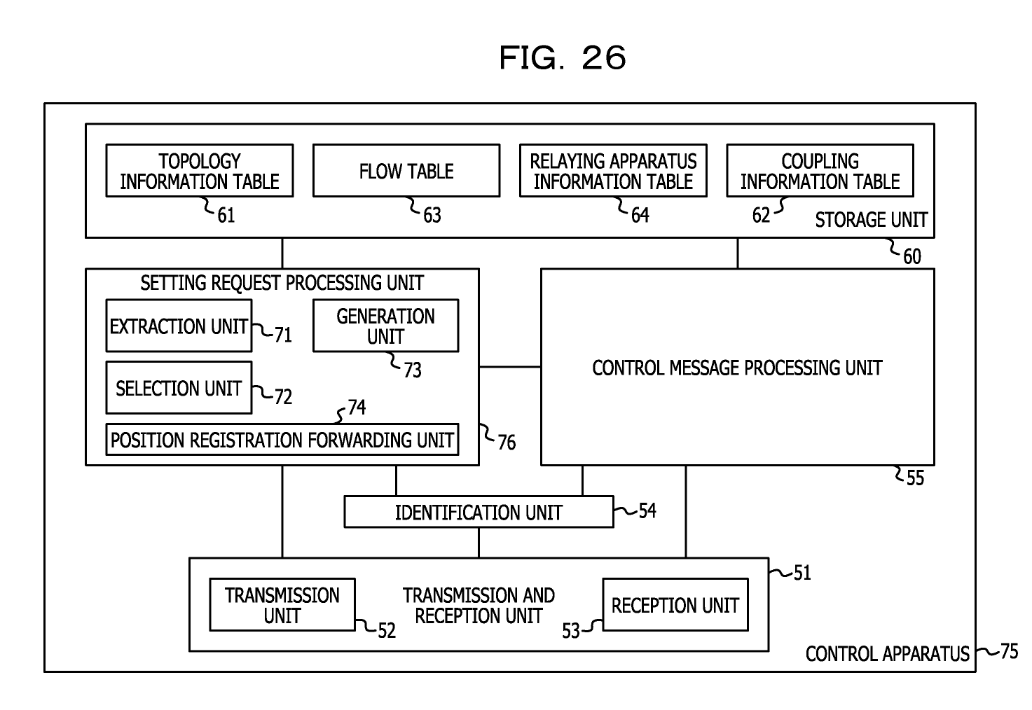

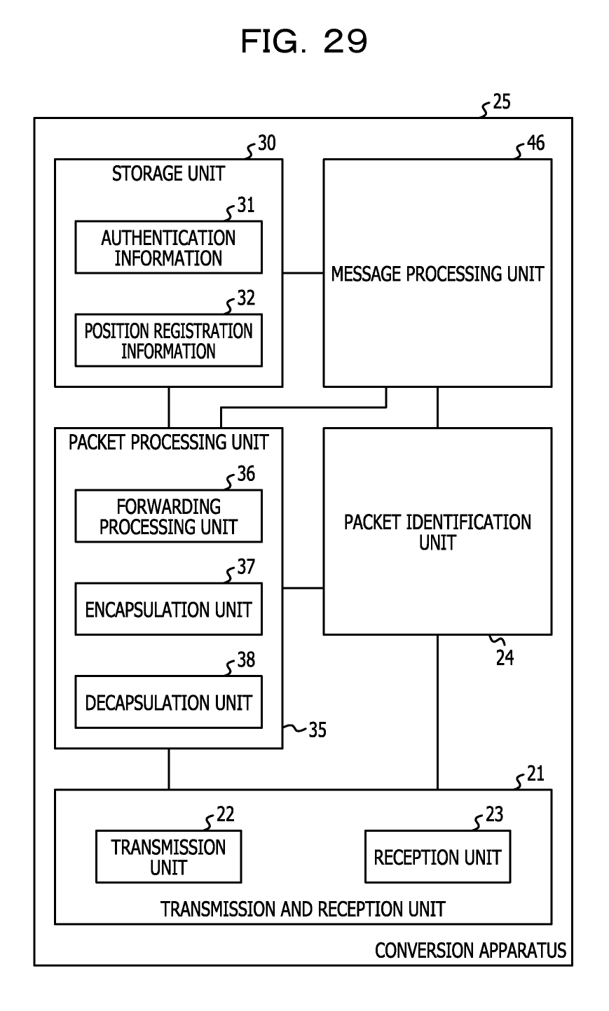

Now, a case is described in which it is detected by a control apparatus (FIG. 26) that a mobile terminal transmits a position registration request to a conversion apparatus (FIG. 29) and update of a flow table held by a relaying apparatus is performed using transmission of the position registration request as a trigger.

FIG. 26 is a block diagram depicting an example of a configuration of a control apparatus according to a third embodiment. A control apparatus 75 includes a transmission and reception unit 51, an identification unit 54, a control message processing unit 55, a storage unit 60, and a setting request processing unit 76. The transmission and reception unit 51, the identification unit 54, the control message processing unit 55 and the storage unit 60 operate similarly to those of the control apparatus 50 used in the first and second embodiments. The setting request processing unit 76 includes an extraction unit 71, a selection unit 72, a generation unit 73 and a position registration forwarding unit 74.

In the third embodiment, it is assumed that a relaying apparatus 80 coupled to a subnetwork can specify a position registration request message. The relaying apparatus 80 transmits a position registration request message to the control apparatus 75 using a controlling line. The control apparatus 75 transmits the position registration request message to a conversion apparatus 25 using the controlling line. The conversion apparatus 25 transmits a position registration response message to the control apparatus 75 using the controlling line.

The identification unit 54 outputs, when a packet inputted thereto is a position registration request message, the position registration request message to the position registration forwarding unit 74. The position registration forwarding unit 74 forwards the position registration request message to the conversion apparatus 25 through a transmission unit 52. Therefore, the position registration request message is transmitted from the control apparatus 75 to the conversion apparatus 25 through the controlling line.

Meanwhile, the extraction unit 71 in the control apparatus 75 can specify the home subnetwork and the movement destination subnetwork of the mobile terminal 10 using the position registration response message. It is to be noted that the position registration response message includes the home address and the care-of address of the mobile terminal 10 and is transmitted as a registration notification for notifying the mobile terminal 10 that the care-of address of the mobile terminal 10 is registered from the conversion apparatus 25 to the mobile terminal 10. The extraction unit 71 notifies the selection unit 72 of the home subnetwork and the movement destination subnetwork of the mobile terminal 10. The processes by the selection unit 72 and the generation unit 73 are similar to those in the first and second embodiments.

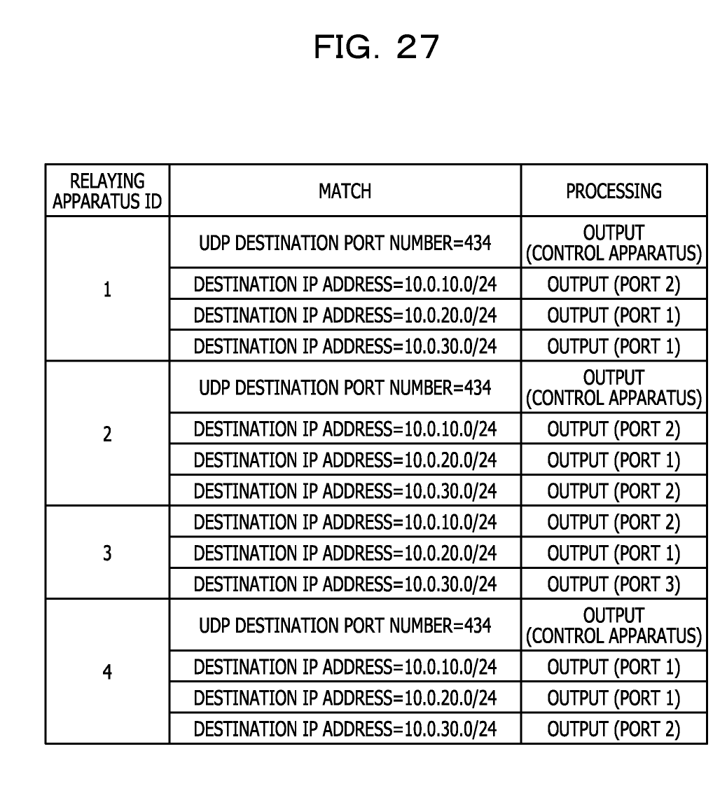

FIG. 27 is a view depicting an example of a flow table. FIG. 27 depicts an example of a flow table 63 held by the control apparatus 75 when the mobile terminal 10 is positioned in the subnetwork 5a that is the home network of the mobile terminal 10. Since the network also in the third embodiment is such as depicted in FIG. 3, in the relaying apparatus 80a, 80b, and 80d each coupled to one of the subnetworks 5a to 5c, a condition to be used for forwarding of a position registration request message is set. It is assumed that, in the position registration request message, the user datagram protocol (UDP) is used and the UDP destination port number is fixed to 434. Further, in a packet other than the position registration request message, the UDP destination port number is set to any other value than 434. Accordingly, if the UDP destination port number is 434, then any relaying apparatus 80 coupled to the subnetwork 5 can decide that a position registration request message is received. Further, the process for a packet whose UDP destination port number is 434 is to output to the controlling line coupled to the control apparatus 75. Therefore, when a position registration request message is received, the relaying apparatus 80 can forward the position registration request message to the control apparatus 75. The information other than the information of the first entry in each of the relaying apparatus 80a, 80b, and 80d is similar to the information of the flow table 63 depicted in FIG. 8.

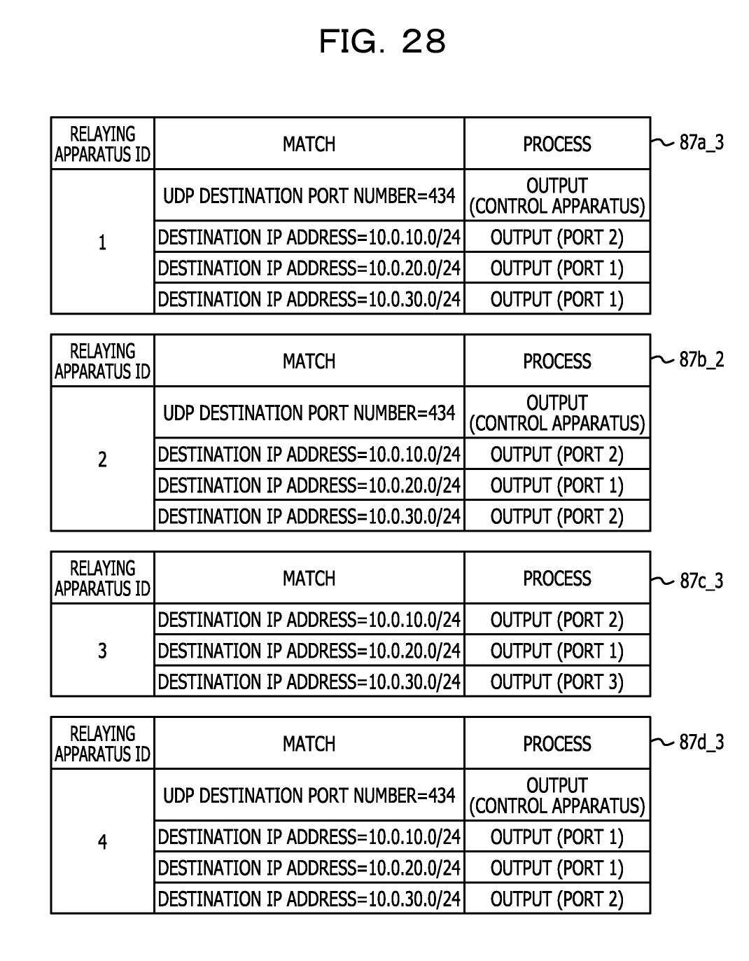

FIG. 28 is a view depicting an example of a flow table held by a relaying apparatus. The relaying apparatus described with reference to FIG. 28 may be the relaying apparatus 80 described with reference to FIG. 2, and the flow table depicted in FIG. 28 may be the flow table 87 depicted in FIG. 9. It is assumed that, at a stage prior to movement of the mobile terminal 10, the relaying apparatus 80a holds the flow table 87a_3; the relaying apparatus 80b holds the flow table 87b_2; the relaying apparatus 80c holds the flow table 87c_3; and the relaying apparatus 80d holds the flow table 87d_3. It is to be noted that the flow table 87a_3 is information of the relaying apparatus ID=1 in the flow table 63 depicted in FIG. 27. Similarly, the flow table 87b_2 is information of the relaying apparatus ID=2; the flow table 87c_3 is information of the relaying apparatus ID=3; and the flow table 87d_3 is information of the relaying apparatus ID=4, extracted from the flow table 63 depicted in FIG. 27.

FIG. 29 is a block diagram depicting an example of a configuration of a conversion apparatus according to the third embodiment. A conversion apparatus 25 includes a transmission and reception unit 21, a packet identification unit 24, a storage unit 30, a packet processing unit 35 and a message processing unit 46. The processes by the transmission and reception unit 21, the packet identification unit 24, the storage unit 30 and packet processing unit 35 are such as described hereinabove with reference to FIG. 4 and so forth.

The message processing unit 46 performs, when a position registration request message is acquired by communication through the controlling line, an authentication process and a position registration. At this time, the message processing unit 46 suitably uses the authentication information 31 to update the position registration information 32. When completing the position registration, the message processing unit 46 designates a forwarding destination of the position registration response message to the control apparatus 75 and then outputs the position registration response message to a transmission unit 22. Therefore, the message processing unit 46 can forward the position registration response message destined for the mobile terminal 10 to the control apparatus 75 using the controlling line through the transmission unit 22.

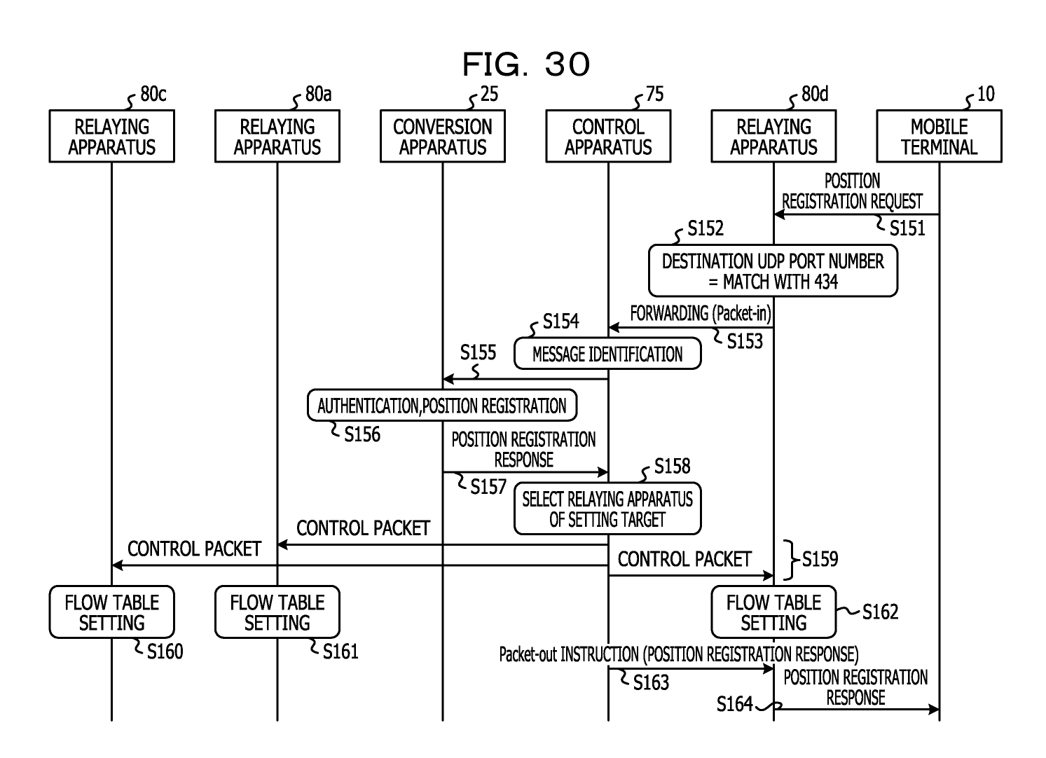

FIG. 30 is a sequence diagram depicting an example of processing performed upon change of a flow table in the third embodiment. In the following, an example wherein the mobile terminal 10 moves from the subnetwork 5a that is the home subnetwork of the mobile terminal 10 to the subnetwork 5c is described. It is to be noted that FIG. 30 illustrates an example of the processing, and, for example, the processes at steps S158 to S162 may be performed after the processes at step S163 and S164, or the processes at steps S158 to S162 may be performed in parallel to the processes at steps S163 and S164.

At step S151, if the mobile terminal 10 detects that the mobile terminal 10 moves from the home subnetwork to the different subnetwork 5c, then the mobile terminal 10 transmits a position registration request message toward the conversion apparatus 25 as a destination. Since the relaying apparatus 80d is positioned on the route from the subnetwork 5c to the conversion apparatus 25 and is coupled to the subnetwork 5c, the relaying apparatus 80d receives the position registration request message.

At step S152, the determination unit 91d of the relaying apparatus 80d acquires the position registration request message through the transmission and reception unit 81d and the sorting unit 82d. Since the serial number of the UDP destination port in the position registration request message is 434, the determination unit 91d selects the first entry in the flow table 87d_3 (FIG. 28) as a condition to be used for forwarding of the packet. The determination unit 91d outputs the information indicative of the substance of the process recorded in the selected entry and the position registration request message to the packet processing unit 93d.

At step S153, the packet processing unit 93d forwards the position registration request message inputted thereto from the determination unit 91d to the control apparatus 75 through the transmission and reception unit 81d. Note that it is assumed that the position registration request message is forwarded from the relaying apparatus 80d to the control apparatus 75 through a path for controlling. The position registration request message is forwarded, for example, using Packet-in of OpenFlow.

At step S154, the identification unit 54 in the control apparatus 75 acquires the position registration request message through the reception unit 53. The identification unit 54 outputs the position registration request message to the position registration forwarding unit 74. The position registration forwarding unit 74 forwards the position registration request message to the conversion apparatus 25 through the transmission unit 52 (step S155). Note that it is assumed that the position registration request message is forwarded from the control apparatus 75 to the conversion apparatus 25 through a path for controlling.

At step S156, the packet identification unit 24 of the conversion apparatus 25 acquires the position registration request message through a reception unit 23. The packet identification unit 24 outputs the position registration request message to the message processing unit 46. The message processing unit 46 performs an authentication process using the parameters included in the position registration request message and performs position registration if the authentication results in success. When the position registration comes to an end, the message processing unit 46 generates a position registration response message destined for the mobile terminal 10. Here, as the header of the position registration response message, the care-of address of the mobile terminal 10 is designated. Further, the home address of the mobile terminal 10 is recorded in the payload of the position registration response message. Accordingly, the position registration response message includes the care-of address and the home address of the mobile terminal 10. The message processing unit 46 designates the forwarding destination for the position registration response message to the control apparatus 75 and then outputs the position registration response message to the transmission unit 22. The transmission unit 22 forwards the position registration response message to the control apparatus 75 in accordance with the designation from the message processing unit 46 (step S157). Note that it is assumed that the position registration response message is forwarded from the conversion apparatus 25 to the control apparatus 75 through a path for controlling.

At step S158, the identification unit 54 in the control apparatus 75 acquires the position registration response message through the reception unit 53. The identification unit 54 outputs the position registration response message to the extraction unit 71. The extraction unit 71 extracts the home address and the care-of address of the mobile terminal 10 from the position registration response message and specifies the home subnetwork and the movement destination subnet of the mobile terminal 10. The selection unit 72 searches for the relaying apparatus 80 included in the route from the home subnetwork to the movement destination subnetwork of the mobile terminal 10 using the topology information table 61 and the coupling information table 62. Also in the present example, it is assumed that the relaying apparatus 80a, 80c, and 80d are selected as a target for requesting a change of the flow table 87 by the selection unit 72. Thereafter, the flow table 63 is changed by the generation unit 73.

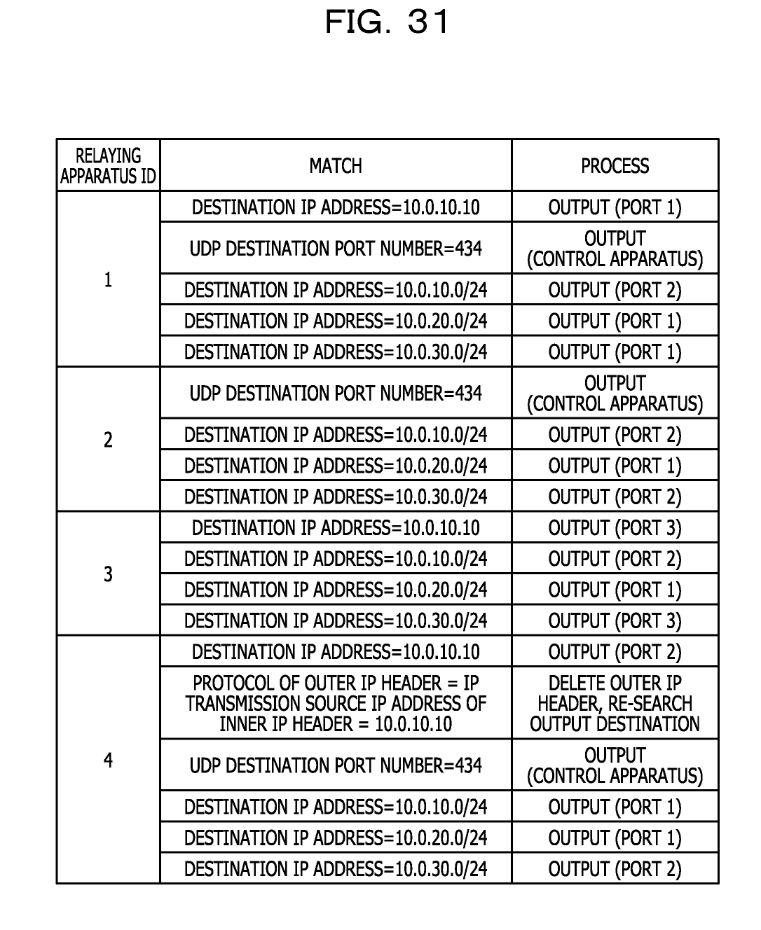

FIG. 31 is a view depicting an example of a change of a flow table. The flow table depicted in FIG. 31 may be the flow table 63 depicted in FIG. 26. The process for change of the flow table 63 is similar to the process for change of the flow table 63 in the first embodiment. The generation unit 73 changes the flow table 63 such that, in each relaying apparatus 80 selected by the selection unit 72, the forwarding destination of a packet destined for the home address of the mobile terminal 10 becomes same as the output port for a packet destined for the movement destination subnet of the mobile terminal 10. By this process, the first entry is added with regard to each of the relaying apparatus ID=1 (relaying apparatus 80a), the relaying apparatus ID=3 (relaying apparatus 80c) and the relaying apparatus ID=4 (relaying apparatus 80d). Further, the generation unit 73 adds an entry such that the relaying apparatus 80 coupled to the movement destination subnetwork performs a forwarding process of an encapsulated packet transmitted from the mobile terminal 10 after the relaying apparatus 80 decapsulates the encapsulated packet. By this process, the second entry of the relaying apparatus ID=4 (relaying apparatus 80d) is added.

At step S159 of FIG. 30, update of the flow table 87 in the relaying apparatus 80 is requested in response to the update of the flow table 63. The process at step S159 is similar to the process at the step S22 (FIG. 12) described in connection with the first embodiment. Also the processes at steps S160 to S162 of FIG. 30 are similar to the processes at steps S23 to S25 described hereinabove with reference to FIG. 12, respectively.

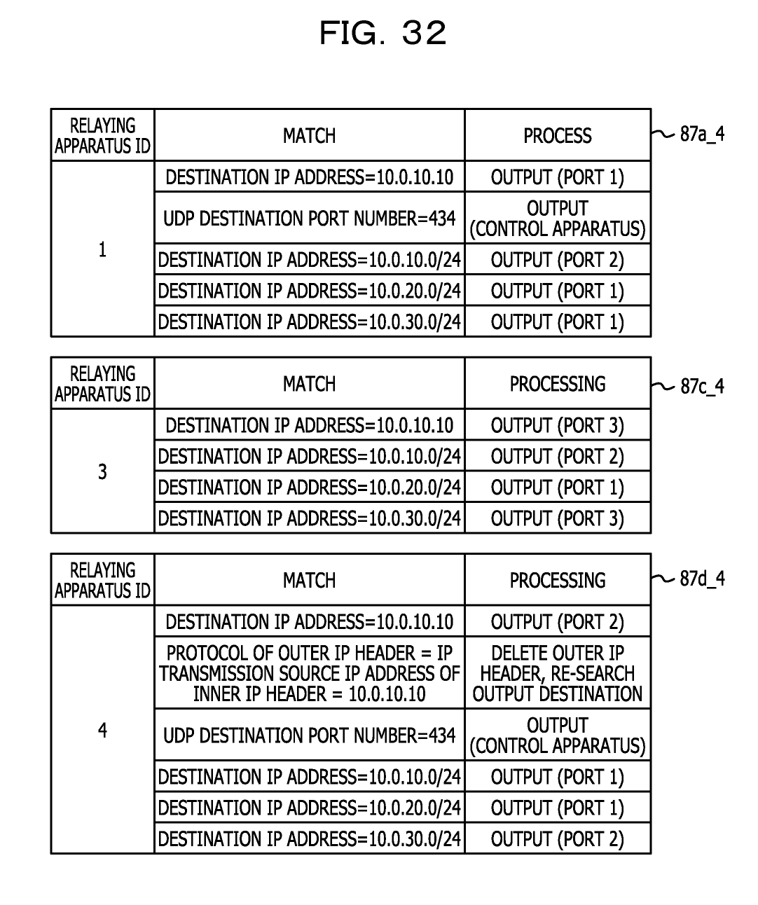

FIG. 32 is a view depicting an example of a flow table after updated. The flow table described with reference to FIG. 32 may be the flow table 87 depicted in FIG. 28. At step S160, the flow table 87c_3 (FIG. 28) is changed into a flow table 87c_4. Similarly, at step S161, the flow table 87a_3 (FIG. 28) is changed into a flow table 87a_4. Further, at step S162, the flow table 87d_3 (FIG. 28) is changed into a flow table 87d_4.

At step S163 of FIG. 30, the position registration forwarding unit 74 of the control apparatus 75 outputs the position registration response message to the relaying apparatus 80d coupled to the movement destination subnetwork. At this time, the position registration forwarding unit 74 notifies the relaying apparatus 80d also that the position registration response message is to be outputted from the port 2 of the relaying apparatus 80d. For example, the position registration forwarding unit 74 can forward the position registration response message to the relaying apparatus 80d using the Packet-Out instruction of OpenFlow. Since the relaying apparatus 80d outputs the position registration response message from the port 2 thereof in accordance with the instruction from the control apparatus 75, the position registration response message is forwarded to the mobile terminal 10 (step S164).

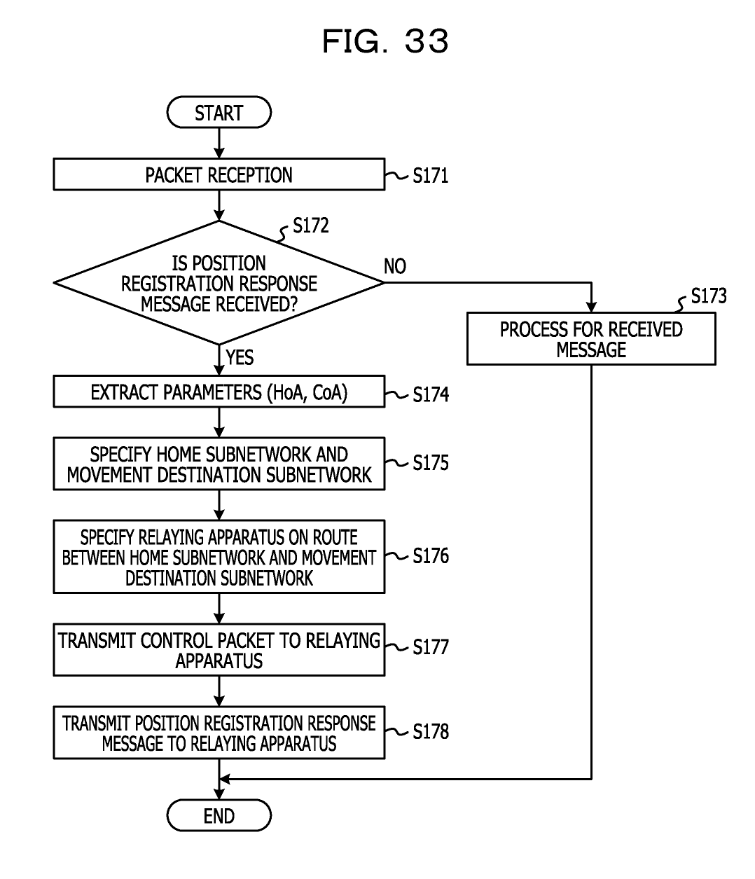

FIG. 33 is a flow chart illustrating an example of processing of a control apparatus. The control apparatus depicted in FIG. 33 may be the control apparatus 75 depicted in FIG. 26. If the control apparatus 75 receives a packet, then the identification unit 54 determines whether a position registration response message is received (steps S171 and S172). The identification unit 54 outputs a packet other than the position registration response message to the control message processing unit 55, and the control message processing unit 55 processes the packet inputted thereto (No at step S172, and step S173).

On the other hand, if the received packet is a position registration response message, then the extraction unit 71 extracts the home address and the care-of address of the mobile terminal 10 from the position registration response message (Yes at step S172, and step S174). The processes at steps S175 to S177 are similar to the processes at steps S75 to S77 described hereinabove with reference to FIG. 20, respectively. Thereafter, the control apparatus 75 forwards the position registration response message to the relaying apparatus 80 coupled to the movement destination subnetwork (step S178).

In the third embodiment, since the setting of the flow table 87 is changed using it as a trigger that position registration is performed, the flow table 87 can be changed prior to starting of communication with the mobile terminal 10. Therefore, packets to be used for communication with the mobile terminal 10 can be transmitted and received in a non-encapsulated state beginning with the first packet, and increase of the communication amount by the outer header can be prevented.

Further, since the conversion apparatus 25 receives a position registration request message from the control apparatus 75, the conversion apparatus 25 may be installed also in any other subnetwork than the home subnetwork of the mobile terminal 10. Therefore, the degree of freedom in arrangement of the apparatus when the network is to be formed is enhanced.

Furthermore, if the relaying apparatus 80 detects a position registration request message, then the relaying apparatus 80 transmits the position registration request message to the control apparatus 75 using a line for transmission and reception of a control message. Then, the position registration request message from the control apparatus 75 is forwarded to the conversion apparatus 25. Therefore, even in a situation in which the transmission delay is great because the amount of packets transmitted and received along a route used for transmission and reception of a data packet is large, the delay amount that is generated in a forwarding process of a position registration request message can be reduced. Also the changing process of the flow table 87 is performed rapidly after the position registration process.

### OTHERS

It is to be noted that the embodiments are not limited to the embodiments described above and can be modified in various manners. In the following, several modifications are described.

The information factors in the tables and packets described above are exemplary and can be changed in accordance with installation.

For example, the second embodiment may be modified such that, after the conversion apparatus 45 detects starting of communication with the mobile terminal 10, rewriting of the flow table 87 by the relaying apparatus 80 is performed before a forwarding process of the received packet is performed. In this case, in the example of FIG. 23, the processes at steps S100 to S105 are performed before the processes at steps S96 to S99. On the other hand, in the example of FIG. 24, the processes at steps S119 to S124 are performed before the processes at steps S115 to S118.

It is to be noted that one or more apparatus in the network may be implemented by a single computer. For example, one or more of the control apparatus 50 and the relaying apparatus 80 may be implemented by a single computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus comprising:
a network interface configured to communicate with a plurality of networks including a first network, the plurality of networks coupling each other via a plurality of relaying apparatus, the first network including a communication apparatus that receives a packet addressed to a first address and transmits the received packet to a second address, the first address being provided for a specific terminal from the first network, the second address being provided for the specific terminal from a second network in the plurality of networks when the specific terminal couples to the second network; and
a processor configured to:
identify at least one relaying apparatus from among the plurality of relaying apparatus, the at least one relaying apparatus lying between the communication apparatus and the specific terminal that couples to the second network, and
transmit at least one control packet to the at least one relaying apparatus, the at least one control packet controlling the at least one relaying apparatus so that a packet addressed to the first address is relayed to the second address.

2. The control apparatus according to claim 1, wherein
one of the at least one control packet further controls one of the at least one relaying apparatus that couples to the second network so that an encapsulated packet from the specific terminal to the communication apparatus is decapsulated and transmitted.

3. The control apparatus according to claim 1, further comprising:
a memory configured to store information on a network configuration of the plurality of networks and the plurality of relaying apparatus,
wherein the processor is configured to:
receive a request packet for the controlling of the at least one relaying apparatus from the communication apparatus,
identify the specific terminal and the second network based on the request packet, and
identify the at least one relaying apparatus based on the identified specific terminal, the identified second network, and the information on the network configuration.

4. The control apparatus according to claim 3, wherein
the request packet includes the first address and the second address, and
the processor is configured to identify the specific terminal based on the first address, and to identify the second network based on the second address.

5. The control apparatus according to claim 1, further comprising:
a memory configured to store information on a network configuration of the plurality of networks and the plurality of relaying apparatus,
wherein the processor is configured to:
receive a notification packet for notifying a registration of the second address that is used in the second network by the specific terminal, the notification packet being transmitted from the communication apparatus to the specific terminal,
identify the specific terminal and the second network based on the notification packet, and
identify the at least one relaying apparatus based on the identified specific terminal, the identified second network, and the information on the network configuration.

6. The control apparatus according to claim 1, wherein
the at least one control packet controls the at least one relaying apparatus so that a packet addressed to the first address is relayed to the second address without encapsulating the packet.

7. The control apparatus according to claim 1, wherein
the at least one control packet controls the at least one relaying apparatus so that a packet addressed to the first address is relayed to not the first address but the second address.

8. The control apparatus according to claim 1, wherein
the communication apparatus is a home agent (HA) of mobile Internet protocol (Mobile IP),
the first address is a home address of the mobile IP, and
the second address is a care of address of the mobile IP.

9. The control apparatus according to claim 1, wherein
the control apparatus is OpenFlow controller (OFC),
the plurality of relaying apparatus are OpenFlow switches (OFS), and
the at least one control packet is transmitted based on OpenFlow.

10. A communication apparatus comprising:
a network interface configured to couple a first network included in a plurality of networks, the plurality of networks coupling each other via a plurality of relaying apparatus; and
a processor configured to:
detect a beginning of communication performed by a specific terminal that is provided with a first address from the first network and couples to a second network in the plurality of networks using a second address provided from the second network, and
transmit a request packet for controlling at least one relaying apparatus so that a packet addressed to the first address is relayed to the second address, the at least one relaying apparatus being the plurality of relaying apparatus that lies between the communication apparatus and the specific terminal that couples to the second network.

11. The communication apparatus according to claim 10, wherein
the processor is configured to detect the beginning of communication by receiving a notification packet for notifying that the specific terminal couples to the second network.

12. The communication apparatus according to claim 10, wherein
the processor is configured to detect the beginning of communication by receiving a data packet to the first address.

13. The communication apparatus according to claim 12, wherein
the processor is configured to detect the beginning of communication by further receiving a capsulated packet that includes data from the specific terminal coupling to the second network and is transmitted to the communication apparatus.

14. A control method comprising:
coupling, by a specific terminal, to a second network in a plurality of networks including a first network, the plurality of networks coupling each other via a plurality of relaying apparatus, the first network including a communication apparatus that receives a packet addressed to a first address and transmits the received packet to a second address, the first address being provided for the specific terminal from the first network, the second address being provided for the specific terminal from the second network when the specific terminal couples to the second network;
identifying, by a control apparatus, at least one relaying apparatus from among the plurality of relaying apparatus, the at least one relaying apparatus lying between the communication apparatus and the specific terminal that couples to the second network; and
transmitting at least one control packet from the control apparatus to the at least one relaying apparatus, the at least one control packet controlling the at least one relaying apparatus so that a packet addressed to the first address is relayed to the second address.
